(19) United States
(12) Patent Application Publication
(10) Pub. No.: US 2024/0069772 A1
(43) Pub. Date: Feb. 29, 2024

(54) STORAGE OPERATION DIE COLLISION AVOIDANCE SYSTEM

(71) Applicant: Dell Products L.P., Round Rock, TX (US)

(72) Inventors: Girish Desai, Fremont, CA (US); Frederick K.H. Lee, Mountain View, CA (US); Dody Suratman, Dublin, CA (US)

(21) Appl. No.: 17/893,616

(22) Filed: Aug. 23, 2022

(51) Int. Cl. G06F 3/06

(52) U.S. Cl. CPC G06F 3/064; G06F 3/0604; G06F 3/0679

(57) ABSTRACT

A storage operation die collision avoidance system includes a storage subsystem providing a first superblock and a second superblock. A storage operation subsystem is coupled to the storage subsystem and performs first storage operations for the first superblock using a first die in the storage subsystem. The storage operation subsystem then determines second storage operations for performance for the second superblock and, without a fixed die storage operation order, identifies a second die in the storage subsystem that is available to perform the second storage operations for the second superblock while at least some of the first storage operations are performed for the first superblock using the first die in the storage subsystem. The storage operation subsystem then performs the second storage operations for the second superblock using the second die in the storage subsystem.

### BACKGROUND

The present disclosure relates generally to information handling systems, and more particularly to avoiding die collisions when performing storage operations using a storage device in an information handling system.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server device and/or other computing devices known in the art utilize storage devices to store data. For example, Solid State Drive (SDD) storage device that include NAND storage subsystems are often utilized with server devices for the storage of data. One technique for storing data in NAND storage subsystems includes the use of “superblocks”, which are a collection physical NAND block from the NAND storage subsystem, and which are considered “open” superblocks when storage program/write operations are being performed on those superblocks, and “closed” superblocks when storage program/write operations are no longer being performed on those superblocks. In many situations, an SSD storage device may have multiple superblocks open. For example, a Central Processing Unit (CPU) or other “host” in a server device may perform storage program/write operations on an open “host superblock”, while a storage engine in the SSD storage device may perform storage program/write operations as part of Garbage Collection (GC)/recycle storage operations on one or more open “recycle superblocks”. However, the performance of storage program/write operations on multiple open superblocks raises issues.

As discussed in further detail below, the multiple open superblocks discussed above may be provided by NAND blocks from the same NAND die/channel combinations in the NAND storage system. For example, a first superblock may be provided by a NAND block 0 in each of the NAND die/channel combinations in a NAND storage subsystem, and a second superblock may be provided by a NAND block 1 in each of the NAND die/channel combinations in the NAND storage subsystem. However, storage operations for different superblocks cannot be performed on the same NAND die at the same time, so in the event a first storage operation is being performed for the first superblock on a NAND die in the NAND storage subsystem and a request to perform a second storage operation for the second superblock on that NAND die in the NAND storage subsystem is received, that request to perform the second storage operation will cause a “die collision” and will be blocked until the first storage operation is completed. As will be appreciated by one of skill in the art in possession of the present disclosure, the die collisions like those discussed above negatively affect the performance of the SSD storage device.

Accordingly, it would be desirable to provide a storage operation die collision avoidance system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a storage operation engine that is configured to: perform first storage operations for a first superblock using a first die in a storage subsystem that provides the first superblock; determine second storage operations for performance for a second superblock provided by the storage subsystem; identify, without a fixed die storage operation order, a second die in the storage subsystem that is available to perform the second storage operations for the second superblock while at least some of the first storage operations are performed for the first superblock using the first die in the storage subsystem; and perform the second storage operations for the second superblock using the second die in the storage subsystem.

### BRIEF DESCRIPTION OF THE DRAWINGS

FIG. 1 is a schematic view illustrating an embodiment of an Information Handling System (IHS).

FIG. 2 is a schematic view illustrating an embodiment of a storage device that may be use the storage operation die collision avoidance system the present disclosure.

FIG. 3A is a schematic view illustrating an embodiment of a storage subsystem that may be provided in the storage device of FIG. 2.

FIG. 3B is a schematic view illustrating an embodiment of a die that may be included in the storage subsystem of FIG. 3A.

FIG. 3C is a schematic view illustrating an embodiment of a plane that may be included in the die of FIG. 3B.

FIG. 3D is a schematic view illustrating an embodiment of a block that may be included in the plane of FIG. 3C.

FIG. 3E is a schematic view illustrating an embodiment of a wordline that may be included in the block of FIG. 3C.

FIG. 4A is a schematic view illustrating an embodiment of the storage subsystems of FIGS. 3A-3E.

FIG. 4B is a schematic view illustrating an embodiment of a first superblock that may be provided using the storage subsystem of FIG. 4A.

FIG. 4C is a schematic view illustrating an embodiment of a second superblock that may be provided using the storage subsystem of FIG. 4A.

FIG. 5A is a schematic view illustrating an embodiment of the performance of conventional storage operations for a superblock.

FIG. 5B is a schematic view illustrating an embodiment of the performance of conventional storage operations for a superblock.

FIG. 5C is a schematic view illustrating an embodiment of the performance of conventional storage operations for a superblock.

FIG. 5D is a schematic view illustrating an embodiment of the performance of conventional storage operations for a superblock.

FIG. 5E is a schematic view illustrating an embodiment of the performance of conventional storage operations for a superblock.

FIG. 5F is a schematic view illustrating an embodiment of the performance of conventional storage operations for a superblock.

FIGS. 6A-6H are schematic views illustrating an embodiment of conventional storage operations for multiple superblocks causing die collisions.

FIG. 7 is a table view illustrating die collisions caused by conventional storage operations for the multiple superblocks.

FIG. 8 is a flow chart illustrating an embodiment of a method for avoiding die collisions when performing storage operations in a storage subsystem.

FIG. 9 is a schematic view illustrating an embodiment of the storage device of FIG. 2.

FIG. 10 is a schematic view illustrating an embodiment of the storage device of FIG. 9 operating during the method of FIG. 8.

FIG. 11 is a schematic view illustrating an embodiment of the storage device of FIG. 9 operating during the method of FIG. 8.

FIG. 12 is a schematic view illustrating an embodiment of the storage device of FIG. 9 operating during the method of FIG. 8.

FIG. 13 is a schematic view illustrating an embodiment of the storage device of FIG. 9 operating during the method of FIG. 8.

FIG. 14 is a schematic view illustrating an embodiment of a storage operation database in the storage device of FIG. 9 during the method of FIG. 8.

FIG. 15 is a flow chart illustrating an embodiment of a method for identifying an idle die during the method of FIG. 8.

FIG. 16 is a schematic view illustrating an embodiment of the storage device of FIG. 9 operating during the method of FIG. 15.

FIG. 17 is a schematic view illustrating an embodiment of a storage operation database in the storage device of FIG. 9 during the method of FIG. 15.

FIG. 18 is a flow chart illustrating an embodiment of a method for identifying die for use in performing storage operations during the method of FIG. 8.

FIG. 19 is a schematic view illustrating an embodiment of the storage device of FIG. 9 operating during the method of FIG. 18.

FIG. 20 is a schematic view illustrating an embodiment of a storage operation database in the storage device of FIG. 9 during the method of FIG. 18.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

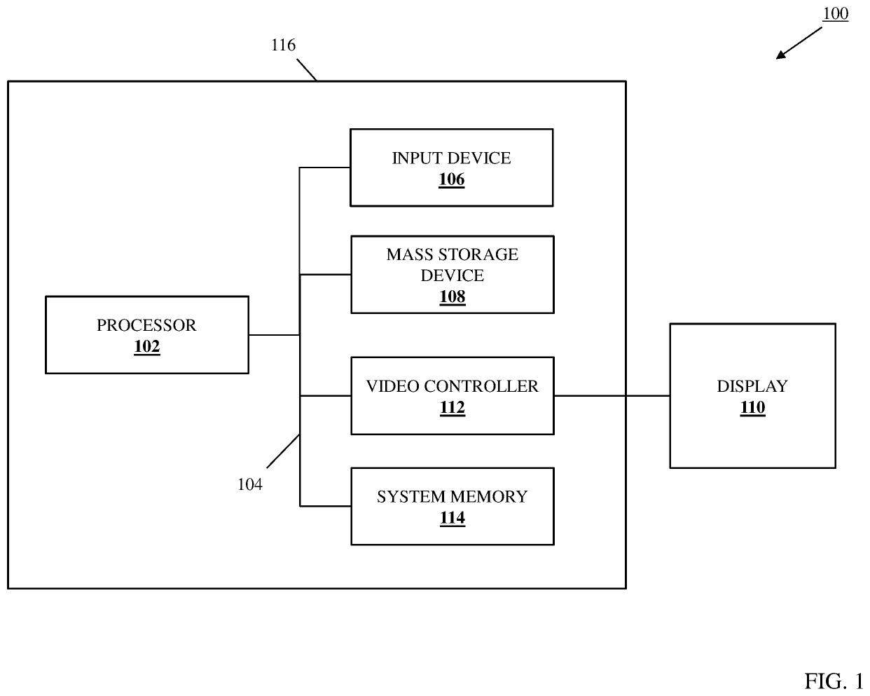

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

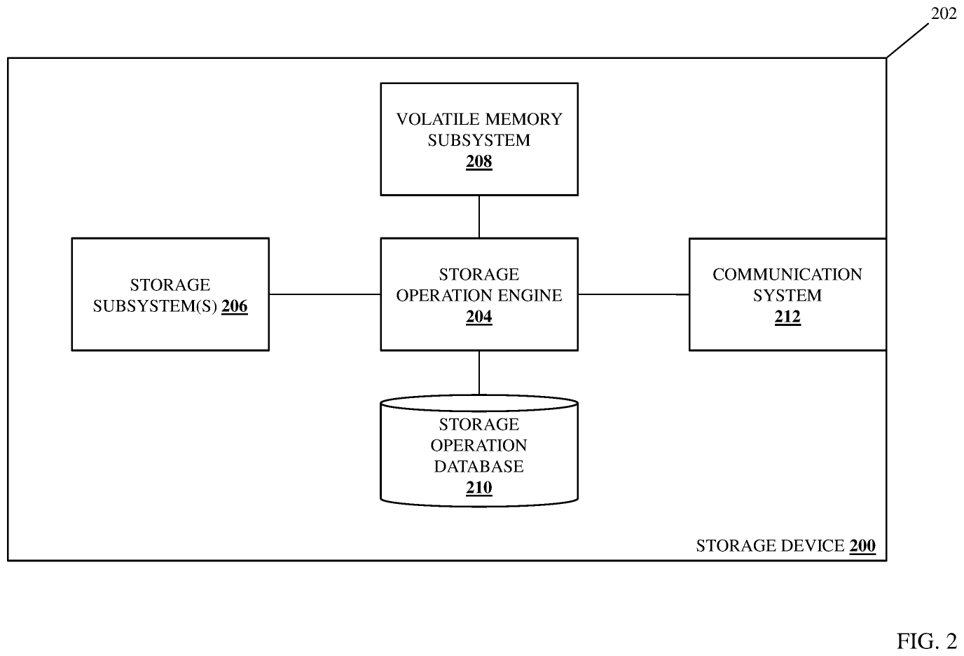

Referring now to FIG. 2, an embodiment of a storage device 200 is illustrated that may utilize the storage operation die collision avoidance system of the present disclosure. As such, the storage device 200 may be provided by the IHS 100 discussed above with reference to FIG. 1 (e.g., as the storage device 108) and/or may include some or all of the components of the IHS 100, and in the specific examples provided below is described as being provided by a Solid State Drive (SSD) storage device. However, while illustrated and discussed as being provided by an SSD storage device, one of skill in the art in possession of the present disclosure will recognize that the functionality of the storage device 200 discussed below may be provided by other devices that are configured to operate similarly as storage device 200 discussed below. In the illustrated embodiment, the storage device 200 includes a chassis 202 that houses the components of the storage device 200, only some of which are illustrated and discussed below. For example, the chassis 202 may house a processing system (not illustrated, but which may include a processor similar to the processor 102 discussed above with reference to FIG. 1, an SSD System On a Chip (SOC), etc.) and a memory system (not illustrated, but which may include a memory device similar to the memory 114 discussed above with reference to FIG. 1) that is coupled to the processing system and that includes instructions that, when executed by the processing system, cause the processing system to provide a storage operation engine 204 that is configured to perform the functionality of the storage operation engines and/or storage devices discussed below.

The chassis 202 may also house one or more storage subsystems 206 that are coupled to the storage operation engine 204 (e.g., via a coupling between the storage subsystem(s) 206 and the processing system), specific examples of which are discussed in further below. In the illustrated embodiment, the chassis 202 also houses a volatile memory subsystem 208 that is coupled to the storage operation engine 204 (e.g., via a coupling between the volatile memory subsystem 208 and the processing system) and that is configured for use by the storage operation engine 204 for the storage of data. Furthermore, while illustrated as separate from the storage operation engine 204, one of skill in the art in possession of the present disclosure will recognize that at least a portion of the volatile memory subsystem 208 may also provide the memory system discussed above that includes the instructions that, when executed by the processing system, cause the processing system to provide the storage operation engine 204 while remaining with the scope of the present disclosure as well. As illustrated, the chassis 202 may also house a storage system (not illustrated, but which may include a storage device similar to the storage device 108 discussed above with reference to FIG. 1) that is coupled to the storage operation engine 204 (e.g., via a coupling between the storage system and the processing system) and that is configured to provide a storage operation database 210 that may store any information utilized by the storage operation engine 204 as discussed below.

The chassis 202 may also house a communication system 212 that is coupled to the storage operation engine 204 (e.g., via a coupling between the communication system 212 and the processing system) and that may be provided by any storage device communication components that one of skill in the art in possession of the present disclosure would recognize as allowing the storage operation engine 204 to communicate with a host system (e.g., a Central Processing Unit (CPU) in a server device or other computing device known in the art) and/or other storage/computing components that would be apparent to one of skill in the art in possession of the present disclosure. However, while a specific storage device 200 has been illustrated and described, one of skill in the art in possession of the present disclosure will recognize that storage devices (or other devices operating according to the teachings of the present disclosure in a manner similar to that described below for the storage device 200) may include a variety of components and/or component configurations for providing conventional storage device functionality, as well as the storage operation die collision avoidance functionality discussed below, while remaining within the scope of the present disclosure as well.

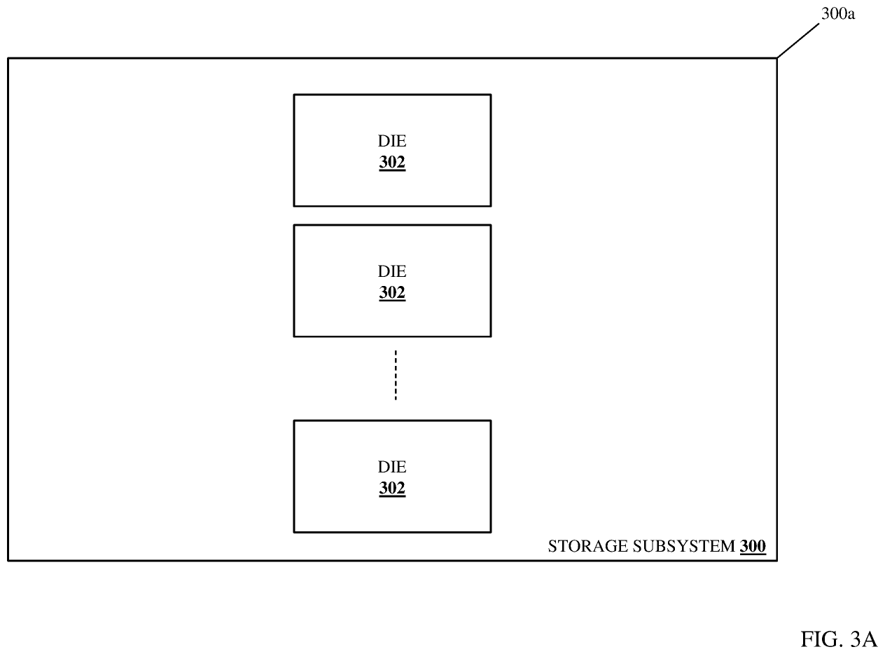

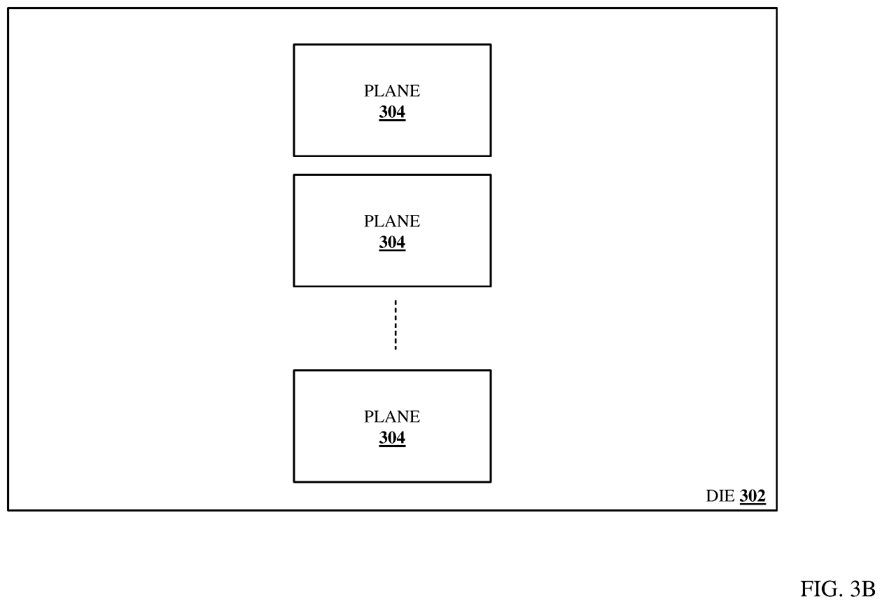

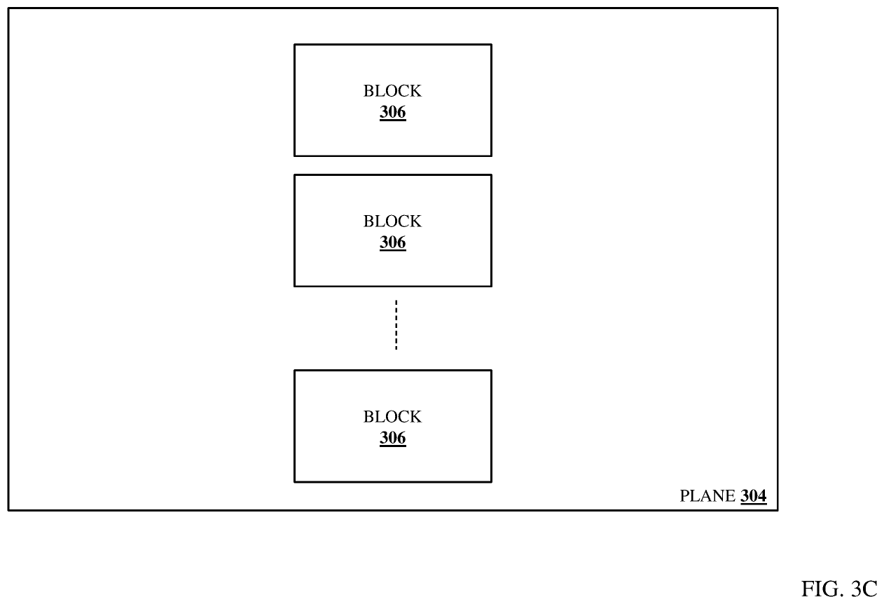

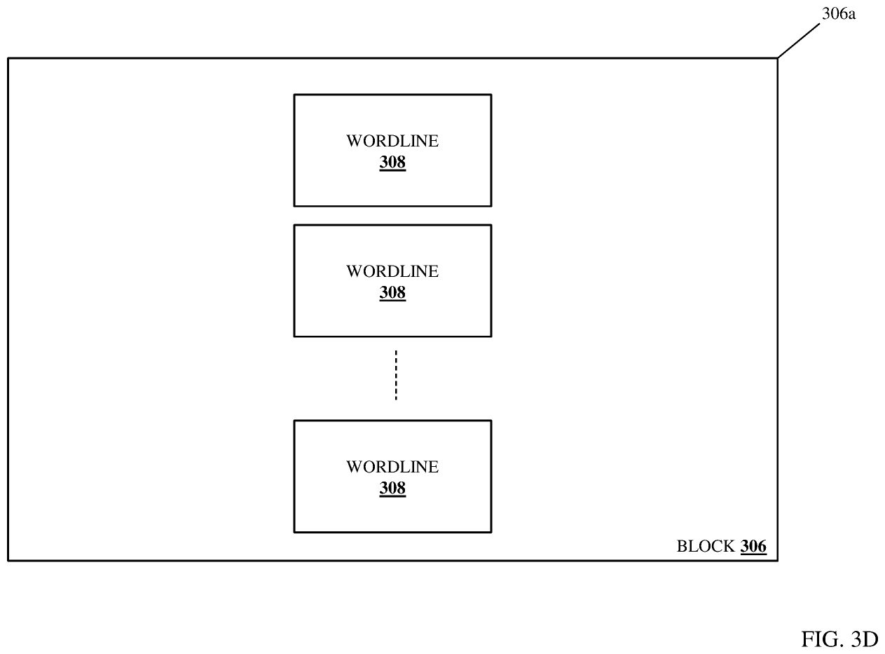

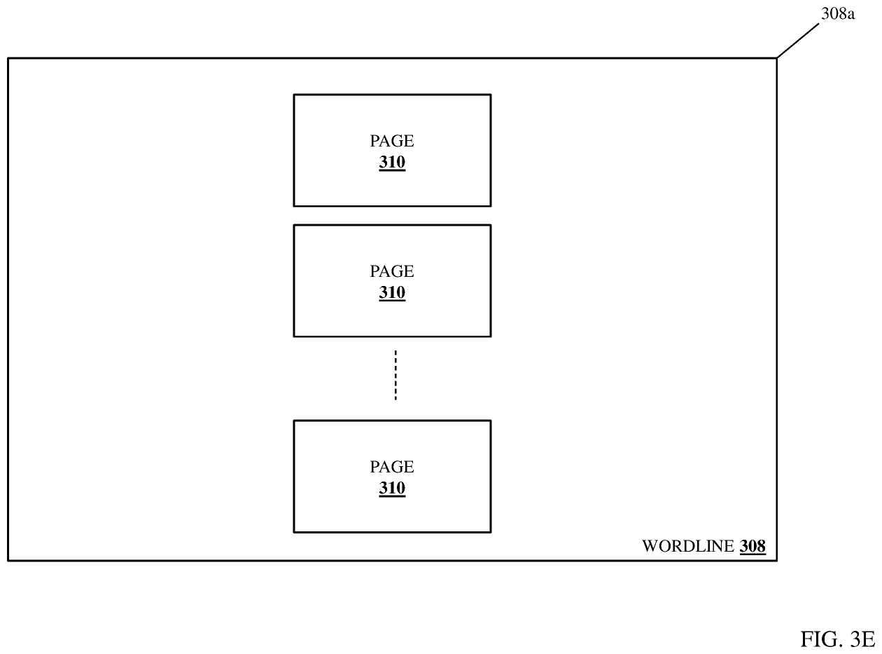

Referring now to FIGS. 3A, 3B, 3C, 3D, and 3E, an embodiment of a storage subsystem 300 is illustrated that may provide the storage subsystem(s) 206 discussed above with reference to FIG. 2. As will be appreciated by one of skill in the art in possession of the present disclosure, the storage subsystem 300 is illustrated and described below as a NAND storage subsystem that may be provided in the SSD storage device discussed above, although one of skill in the art in possession of the present disclosure will recognize that the teachings of the present disclosure may be provided in other storage subsystem technologies while providing the benefits discussed below, and thus those other storage technologies are envisioned as falling within the scope of the present disclosure as well.

With reference to FIG. 3A, the storage subsystem 300 may include a chassis 300a (e.g., a NAND package, circuit board, or other storage subsystem chassis that would be apparent to one of skill in the art in possession of the present disclosure) that supports a plurality of die 302 (e.g., NAND die). Furthermore, with reference to FIGS. 3B, 3C, 3D, and 3E, each of the die 302 may include a plurality of planes 304 (e.g., NAND planes), each of the planes 304 may include a plurality of blocks 306 (e.g., NAND blocks), each of the blocks 306 may include a plurality of wordlines 308, (e.g., NAND wordlines) and each of the wordlines 308 may include a plurality of pages 310 (e.g., NAND pages). One of skill in the art in possession of the present disclosure will appreciate how the number, types, configurations, and other characteristics of die 302, planes 304, blocks 306, wordlines 308, and pages 310 will vary between different storage subsystems, and how the functionality of the storage operation die collision avoidance system of the present disclosure may be agnostic to any or all of these storage subsystem parameters.

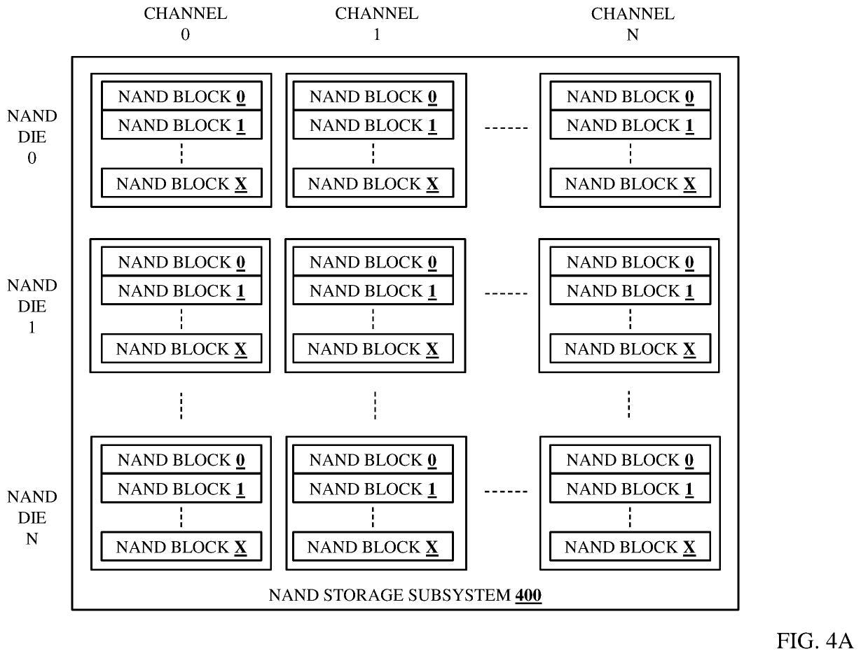

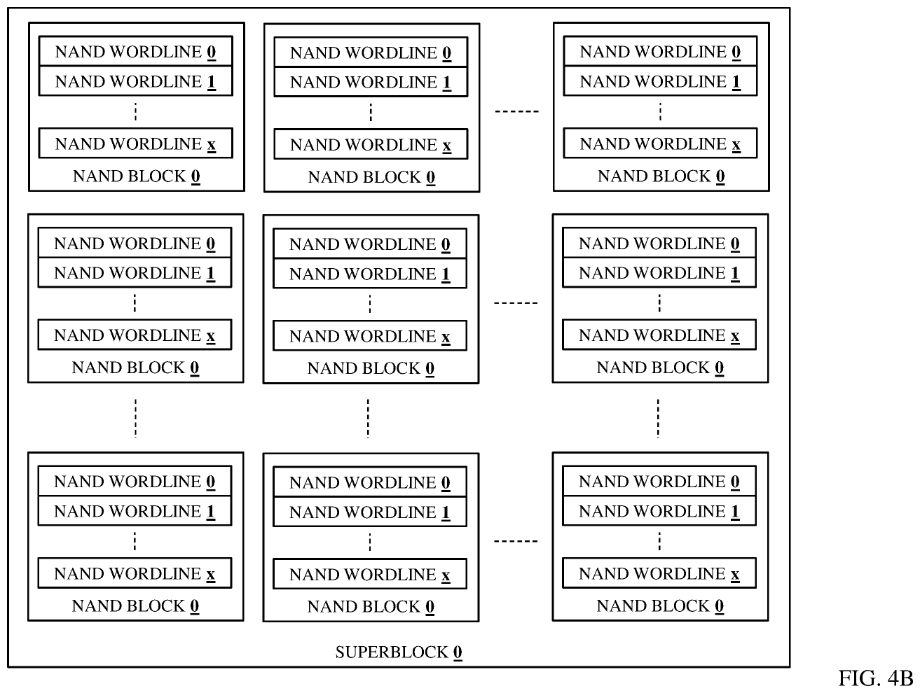

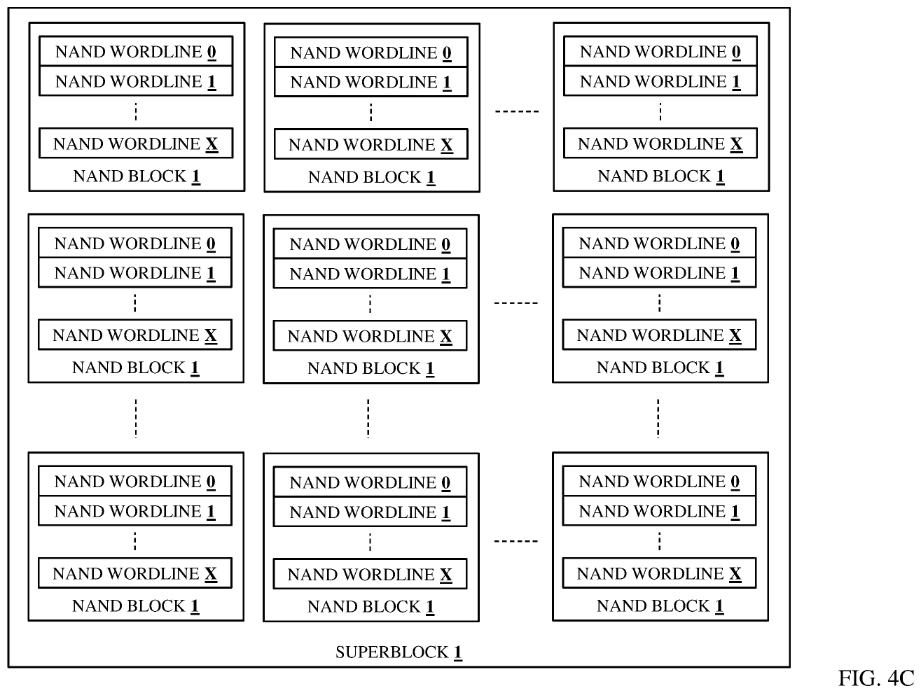

With reference to FIGS. 4A, 4B, and 4C, an embodiment of the provisioning of superblocks using a NAND storage subsystem is illustrated and described for purposes of discussing both the deficiencies in the prior art and the benefits of the teachings of the present disclosure. As illustrated in FIG. 4A, a NAND storage subsystem 400 may include a plurality of NAND die 0, 1, and up to N (e.g., which may be provided by the die 302 discussed above with reference to FIG. 3A), with each NAND die 0-N associated with a plurality of channels 0, 1, and up to N in the NAND storage subsystem 400. Furthermore, each NAND die/channel combination (e.g., a NAND die 0/channel 0 combination, a NAND die 0/channel 1 combination, etc.) in the NAND storage subsystem 400 may include a plurality of NAND blocks 0, 1, and up to X (e.g., which may be provided by the blocks 306 discussed above with reference to FIG. 3C).

With reference to FIG. 4B, a superblock 0 is illustrated that may be provided using the NAND storage subsystem 400. As illustrated in FIG. 4B, the superblock 0 is provided using the NAND block 0 included in each of the NAND die/channel combinations in the storage subsystem 400 (e.g., a NAND block 0 provided by the NAND die 0/channel 0 combination, a NAND block 0 provided by the NAND die 0/channel 1 combination, etc.), and each NAND block 0 that provides the superblock 0 includes a plurality of NAND wordlines 0, 1, and up to x (e.g., which may be provided by the wordlines 308 discussed above with reference to FIG. 3D). Similarly, with reference to FIG. 4C, a superblock 1 is illustrated that may be provided using the NAND storage subsystem 400. As illustrated in FIG. 4C, the superblock 1 is provided using the NAND block 1 included in each of the NAND die/channel combinations in the storage subsystem 400 (e.g., a NAND block 1 provided by the NAND die 0/channel 0 combination, a NAND block 1 provided by the NAND die 0/channel 1 combination, etc.), and each NAND block 1 that provides the superblock 1 includes a plurality of NAND wordlines 0, 1, and up to x (e.g., which may be provided by the wordlines 308 discussed above with reference to FIG. 3D).

As such, superblocks may be provided by a collection of physical NAND blocks in a NAND storage subsystem, and a fixed number of NAND blocks may be selected from every NAND die in the NAND storage subsystem in order to provide each superblock, and one of skill in the art in possession of the present disclosure will appreciate how the highest NAND die parallelism may be achieved during program/write or erase storage operations on superblocks via the selection of NAND blocks from all the NAND die in the NAND storage subsystem to form the superblocks. Furthermore, at a Firmware Translation Layer (FTL)/application layer of storage firmware in the storage device, program/write storage operations are performed on a superblock basis, with a first superblock selected, erased, and then programmed/written completely, following by a second superblock being selected, erased, and then programmed/written completely, etc.

As will be appreciated by one of skill in the art in possession of the present disclosure, a superblock that is currently being programmed/written may be referred to as an “open” superblock, while a superblock that was previously completely programmed/written and is not currently being programmed/written may be referred to as a “closed” superblock. Furthermore, once a host system (e.g., the CPU in the server device discussed above) deallocates, overwrites, or otherwise updates some of the data in a superblock, that data (“old” data) will become “invalid” (e.g., because an updated version of that data exists elsewhere in the NAND storage subsystem), while some of the data in that superblock will remain valid and may eventually be moved to another superblock via storage operations referred to as “garbage collection” or “recycling” storage operations. As will be appreciated by one of skill in the art in possession of the present disclosure, garbage collection/recycling storage operations may operate to move all remaining valid data in a first superblock to a second superblock, after which the first superblock may be subject to an erase storage operation and is then available for a subsequent program/write storage operation.

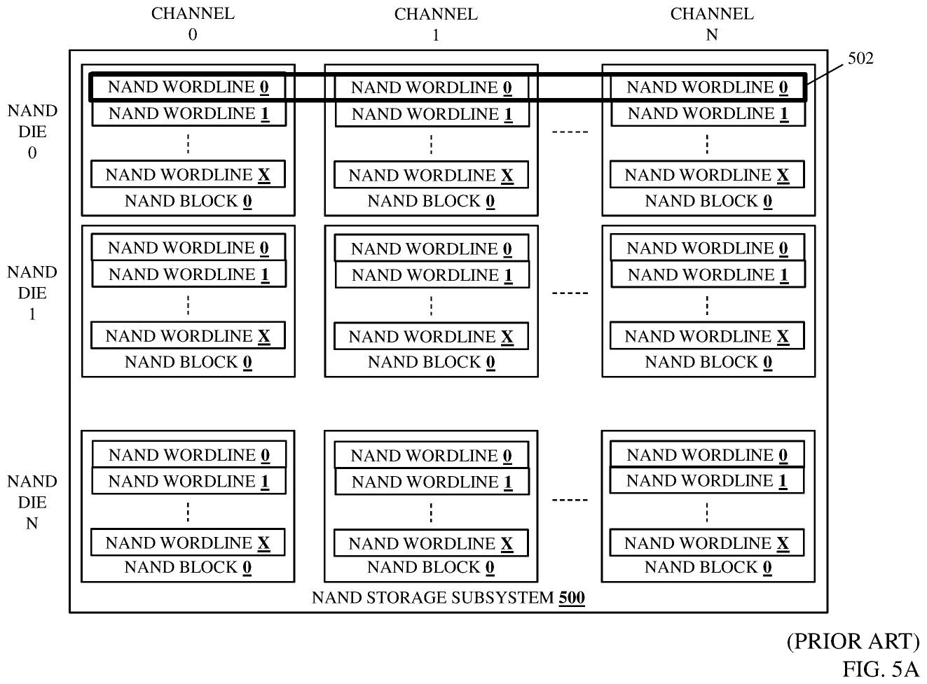

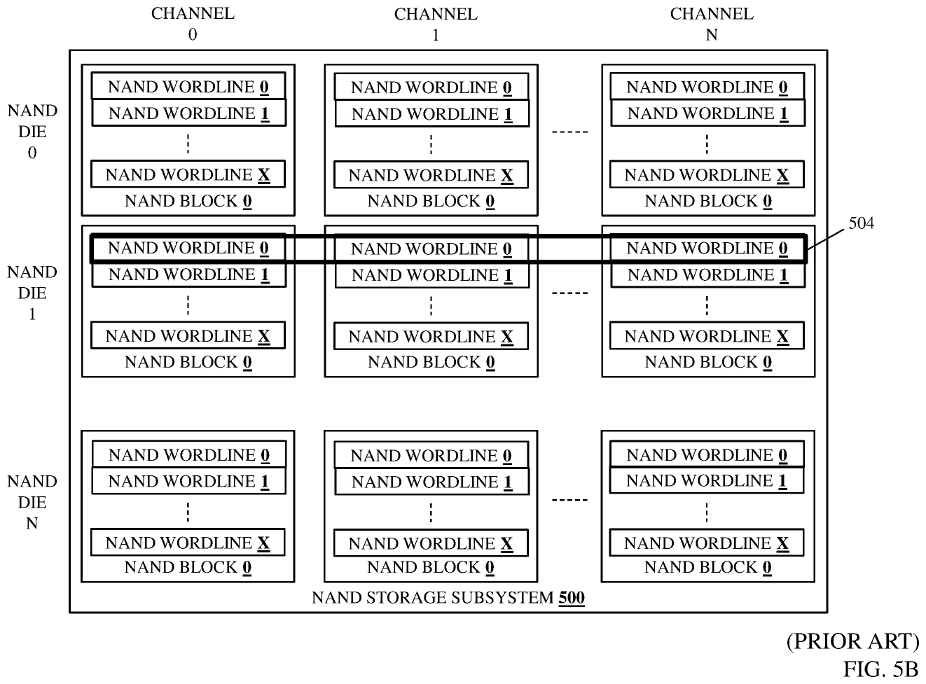

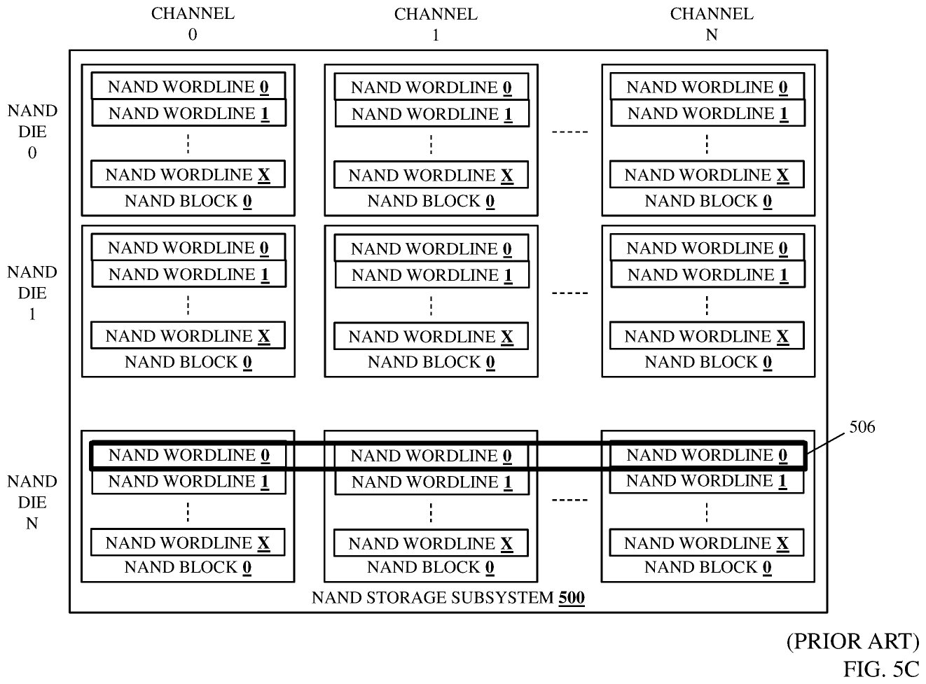

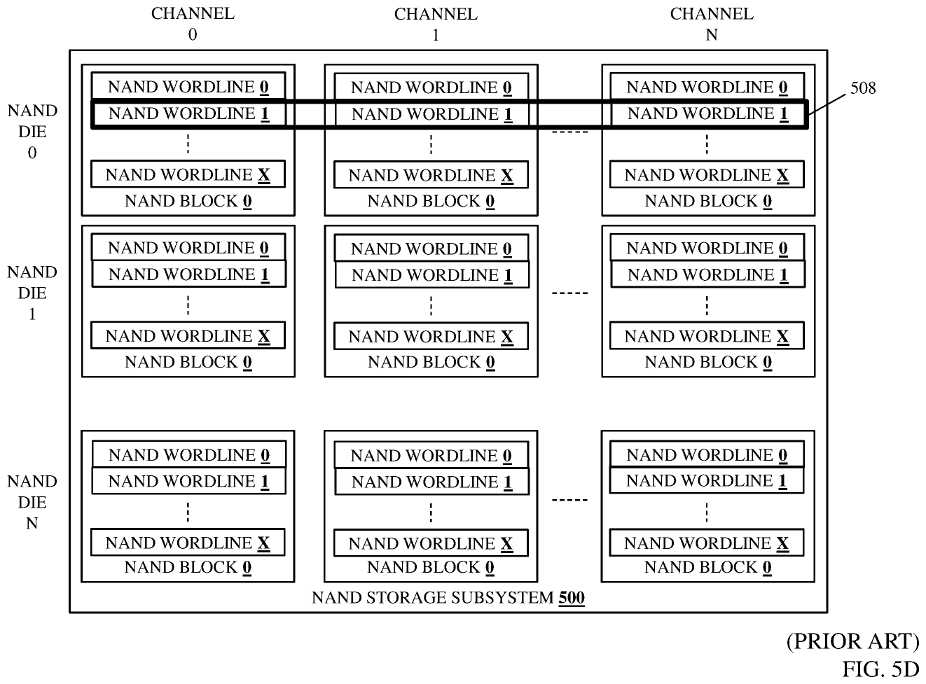

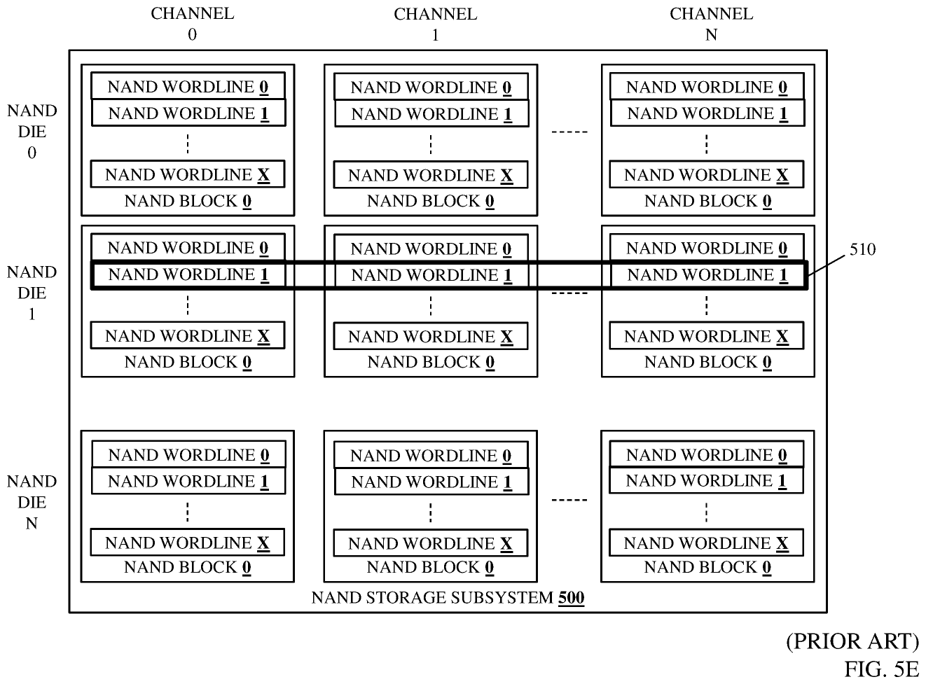

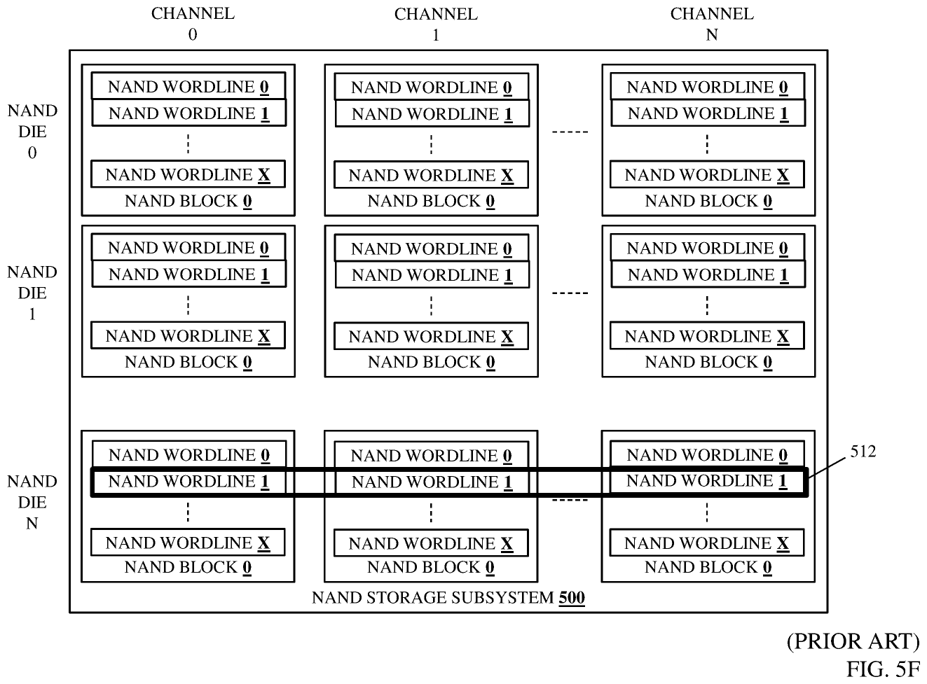

With reference to FIGS. 5A, 5B, 5C, 5D, 5E, and 5F, an embodiment of the performance of conventional programming/writing storage operations for a superblock is illustrated. As illustrated, a NAND storage subsystem 500 may include a plurality of NAND die 0, 1, and up to N (e.g., which may be provided by the die 302 discussed above with reference to FIG. 3A), with each NAND die 0-N associated with a plurality of channels 0, 1, and up to N in the NAND storage subsystem 500. Furthermore, in the illustrated embodiment, each NAND die/channel combination (e.g., a NAND die 0/channel 0 combination, a NAND die 0/channel 1 combination, etc.) in the NAND storage subsystem 500 includes NAND blocks 0 (e.g., which may be provided by the blocks 306 discussed above with reference to FIG. 3C) that provide a superblock (e.g., the superblock 0 discussed above with reference to FIG. 4B), with each NAND block 0 including a plurality of NAND wordlines 0, 1, and up to X (e.g., which may be provided by the wordlines 308 discussed above with reference to FIG. 3D).

With reference to FIGS. 5A, 5B, and 5C, first, second, and Nth “program/write windows” are illustrated in which program/write storage operations 502, 504, and 506, respectively, are performed on the NAND wordlines 0 in each of the NAND die 0/channel 0-N combinations, the NAND die 1/channel 0-N combinations, and up to the NAND die N/channel 0-N combinations, respectively. Similarly, with reference to FIGS. 5D, 5E, and 5F, first, second, and Nth program/write windows are illustrated in which program/write storage operations 508, 510, and 512, respectively, are performed on the NAND wordlines 1 in each of the NAND die 0/channel 0-N combinations, the NAND die 1/channel 0-N combinations, and up to the NAND die N/channel 0-N combinations, respectively. While not explicitly illustrated, one of skill in the art in possession of the present disclosure will appreciate how similar program/write storage operations may be performed in program/write windows on the NAND wordlines up to the NAND wordlines X illustrated in FIGS. 5A-5F.

As will be appreciated by one of skill in the art in possession of the present disclosure, the storage operation engine in a storage device (e.g., similar to the storage operation engine 204 in the storage device 200 discussed above with reference to FIG. 2) may collect an amount of data (e.g., a “data chunk”) in a volatile memory subsystem (e.g., the volatile memory subsystem 208 discussed above with reference to FIG. 2) that corresponds to the storage space provided by the wordlines in every die and all the channels that provide the superblock, and will then program/write that data for the open superblock (e.g., the open superblock 0 discussed above with reference to FIG. 4B) in the manner illustrated in FIGS. 5A-5F. As will be appreciated by one of skill in the art in possession of the present disclosure, the first write window illustrated in FIG. 5A writes data having a “window size” to a “window die” provided by NAND die 0 for the open superblock, the second write window illustrated in FIG. 5B writes data having a “window size” to a “window die” provided by NAND die 1 for the open superblock, etc.

As will be appreciated by one of skill in the art in possession of the present disclosure, when program/write storage operations are performed on the open superblock as discussed above, the NAND die 0 that provides a “first” window die and will be used to perform the program/write storage operations 502 and will become busy with the program/write storage operations 502, and in order to achieve die parallelism the storage operation engine/storage device firmware will advance to the NAND die 1 that provides a “second” window die to perform the program/write storage operations 504 and up to the NAND die N that provides the “Nth” window die to perform the program/write storage operations 506 while the NAND die 0 is busy. Furthermore, once each of the NAND die 0-N are busy as discussed above, the program/write storage operations 508 on the NAND die 0 will be delayed until the program/write storage operations 502 on the NAND die 0 have completed. Similarly, the program/write storage operations 510 on the NAND die 1 will be delayed until the program/write storage operations 504 on the NAND die 1 have completed, the program/write storage operations 512 on the NAND die N will be delayed until the program/write storage operations 506 on the NAND die N have completed, and this will continue until the programming/writing of the superblock has been completed.

As such, the conventional programming/writing of data to a superblock follows a fixed die pattern, an example of which is described above by the “looping” of the NAND die 0-to-1-to-N while advancing to the next NAND wordline at the end of each loop. Furthermore, in some storage subsystems, “secondary” data may be generated or collected and stored in the superblock along with the “primary” data. For example, in order to provide error correction/data recovery capabilities for the NAND storage subsystem, secondary parity/XOR data may be generated and stored in the superblock at fixed intervals between the primary data, with the fixed interval storage of that secondary parity/XOR data in the fixed storage pattern of the primary data making it relatively simple to retrieve that secondary parity/XOR data during error correction/data recovery operations. To provide an example using the superblock storage operations discussed above with reference to FIGS. 5A-5F, primary data may be stored as part of the program/write storage operations 502 and 504, secondary parity/XOR data may be stored as part of the program/write operations 506, primary data may be stored as part of the program/write storage operations 508 and 510, secondary parity/XOR data may be stored as part of the program/write operations 512, and so on.

As discussed above, a storage subsystem will often include multiple open superblocks such as in the host superblock/recycle superblock scenarios discussed above, as part of the use of recycle superblocks for the purposes of NAND/non-volatile memory data reliability operations, in Non-Volatile Memory express (NVMe) SSD storage devices that include a Zoned NameSpace (ZNS) feature that allows data associated with different zones to be written to different superblocks, and/or in other multi-superblock situations that would be apparent to one of skill in the art in possession of the present disclosure. In a specific example of the host superblock/recycle superblock scenarios discussed above and for the purposes of the discussion of the die collision example provided below, host superblock program/write windows may be interleaved with recycle superblock program/write windows based on an amount of data being recycled and the time available to complete the garbage collection/recycle storage operations, write amplification (e.g., for a write amplification of 4, a single host superblock program/write storage operation may be interleaved with three recycle superblock program write operations), and/or other factors that would be apparent to one of skill in the art in possession of the present disclosure.

As discussed above, the physical NAND blocks in an open superblock provided by a storage subsystem will share NAND die with the physical NAND blocks in other superblocks provided by the storage subsystem. Furthermore, because NAND storage operations such as program/write storage operations and erase storage operations cannot be performed on a window die at the same time, conventional NAND storage subsystems operate to serialize such NAND storage operations that will be performed on the same window die by different superblocks provided by that NAND storage subsystem using the storage operation window process described above. However, when multiple superblocks are open, storage operation windows for the multiple superblocks may fall on the same window die at the same time when conventional program/write ordering is utilized, or a second storage operation window for a second superblock may fall on a window die while a first storage operation window for a first superblock is currently being performed on that window die. In such scenarios, the second storage operations in the second storage operation request for the second superblock will be blocked while the first storage operations in the first storage operation request for the first superblock are being performed even if other window die (e.g., the “next” or subsequent window die in the conventional program write order) are unused or otherwise idle, as the storage operation order is fixed in such scenarios as discussed above.

The blocking of storage operations in a storage operation request as described above is referred to as a “die collision”, as the second storage operations in the second storage operation request are blocked because they are to-be performed on a die that is already being used to perform first storage operations. As discussed above, die collisions leave die idle in the storage subsystem, and thus negatively impact the performance of the storage subsystem and storage device. In many storage subsystems, the relatively short duration of read storage operations (˜70 μs) as compared to program/write storage operations (˜2 ms) and erase storage operations (˜5 ms), along with the desire to reduce read latency during read storage operations, results in the storage subsystem being configured to allow the program/write storage operations and erase storage operations to be suspended for the read storage operations. However, program/write storage operations and erase storage operations are not configured to suspend each other in storage subsystems, and that combined with relatively longer program/write storage operation times and/or erase storage operation times cause program/write storage operation-program/write storage operation die collisions, program/write storage operation-erase storage operation die collisions, and erase storage operation-program/write storage operation die collisions to amplify the impact of the die collisions discussed above.

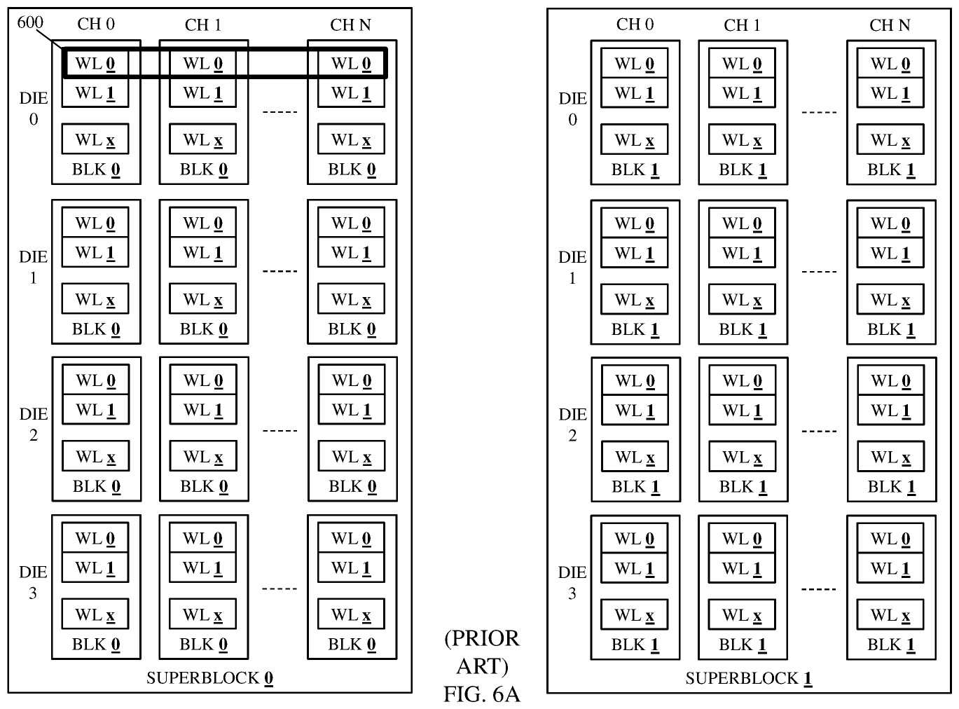

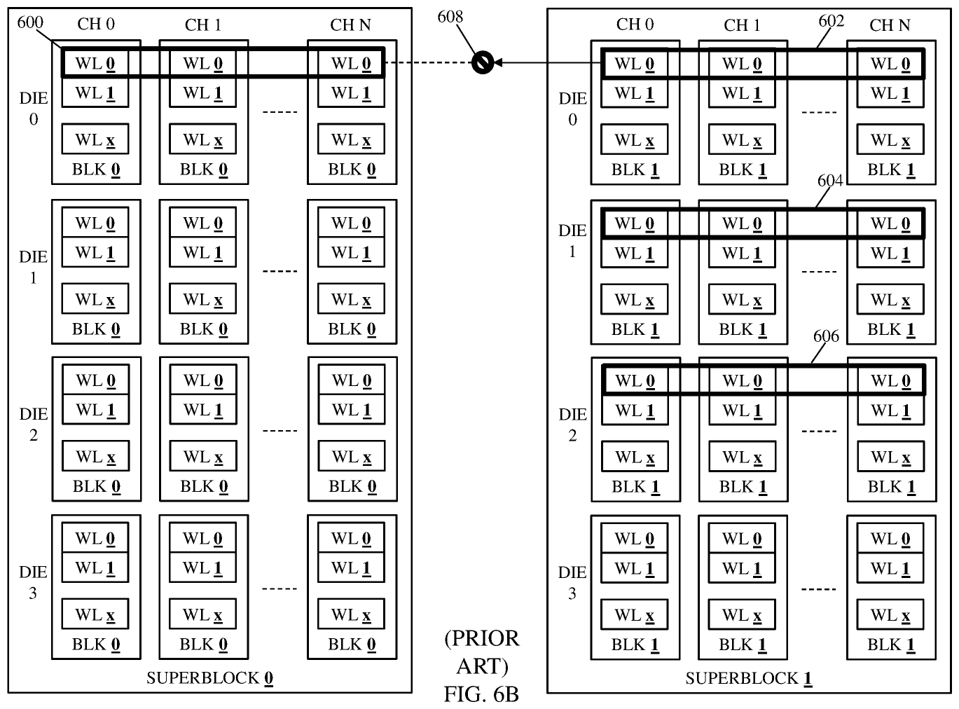

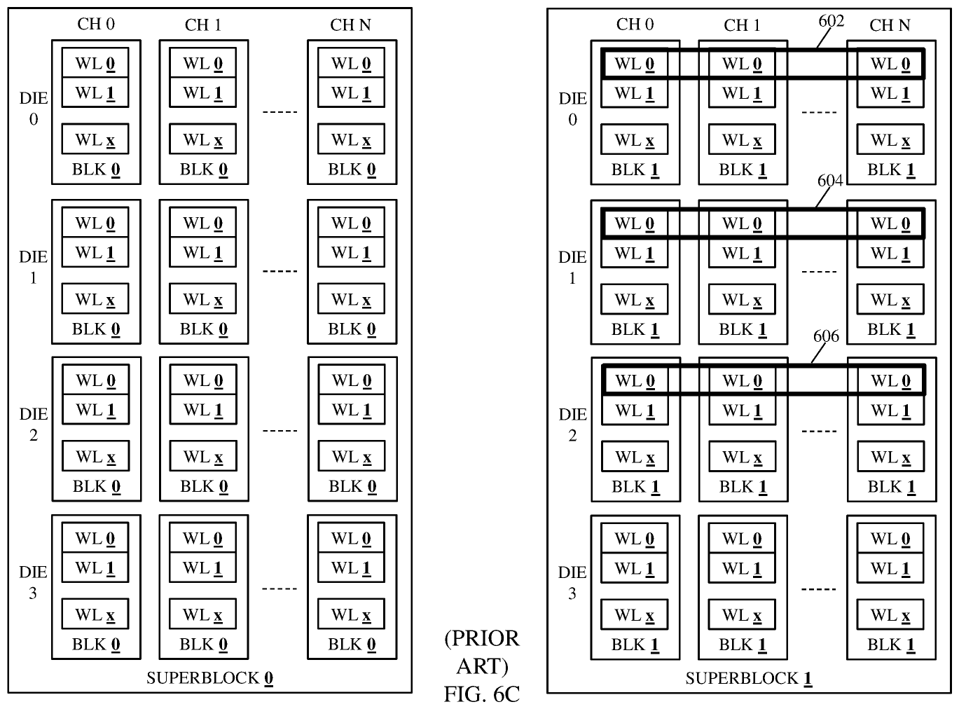

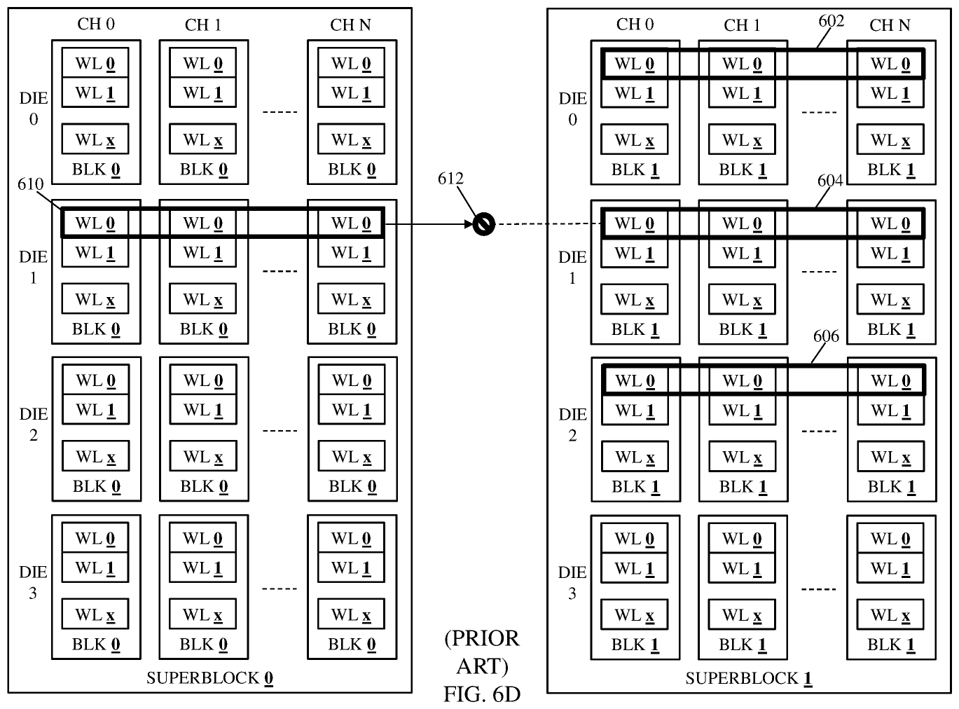

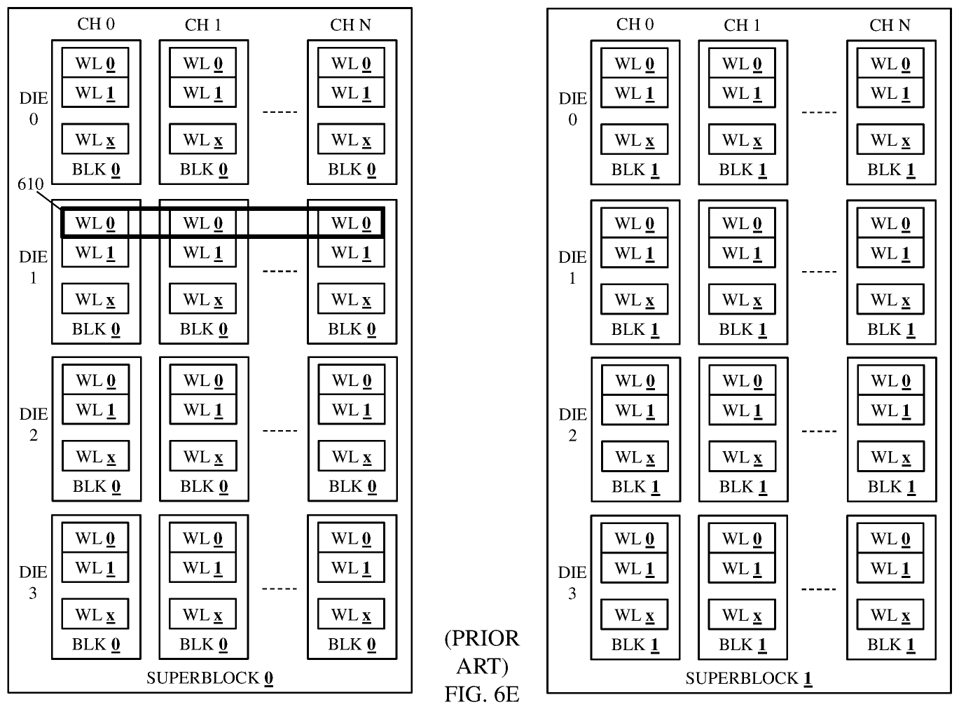

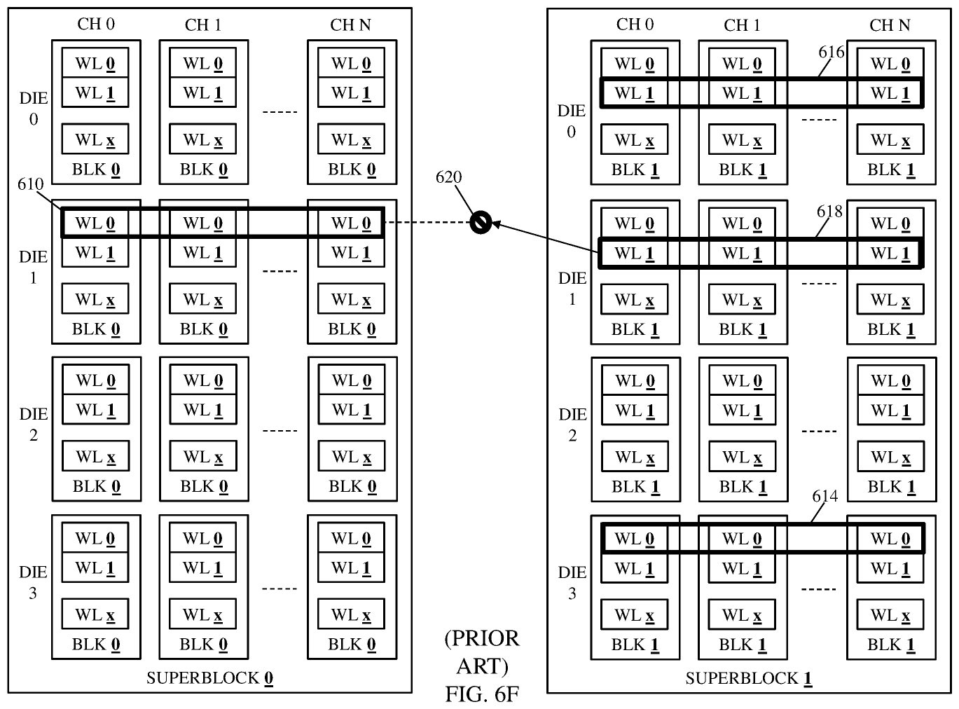

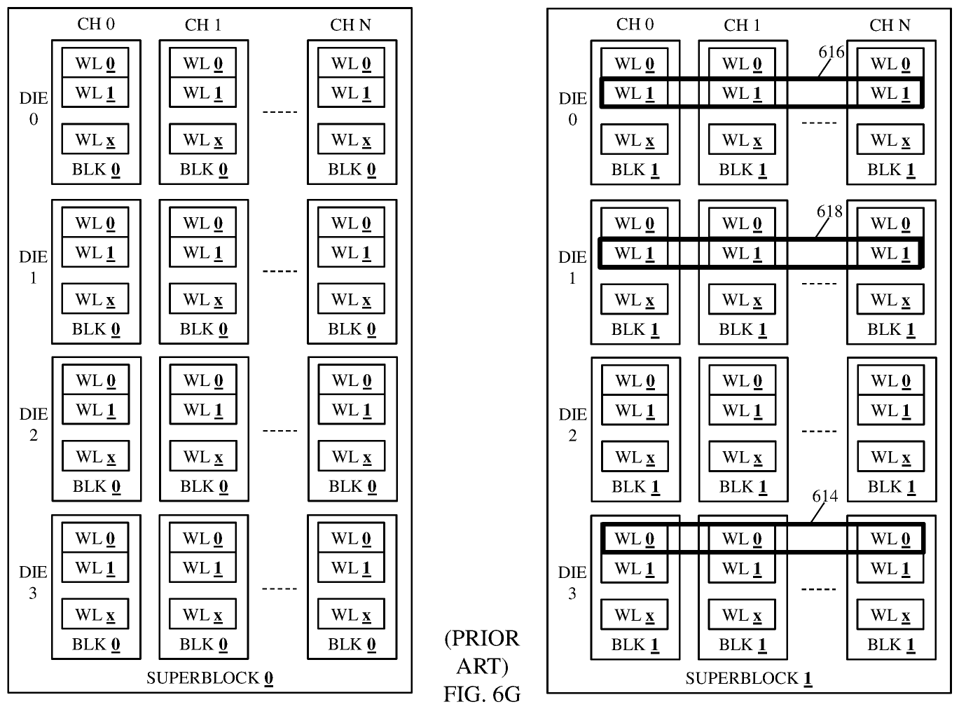

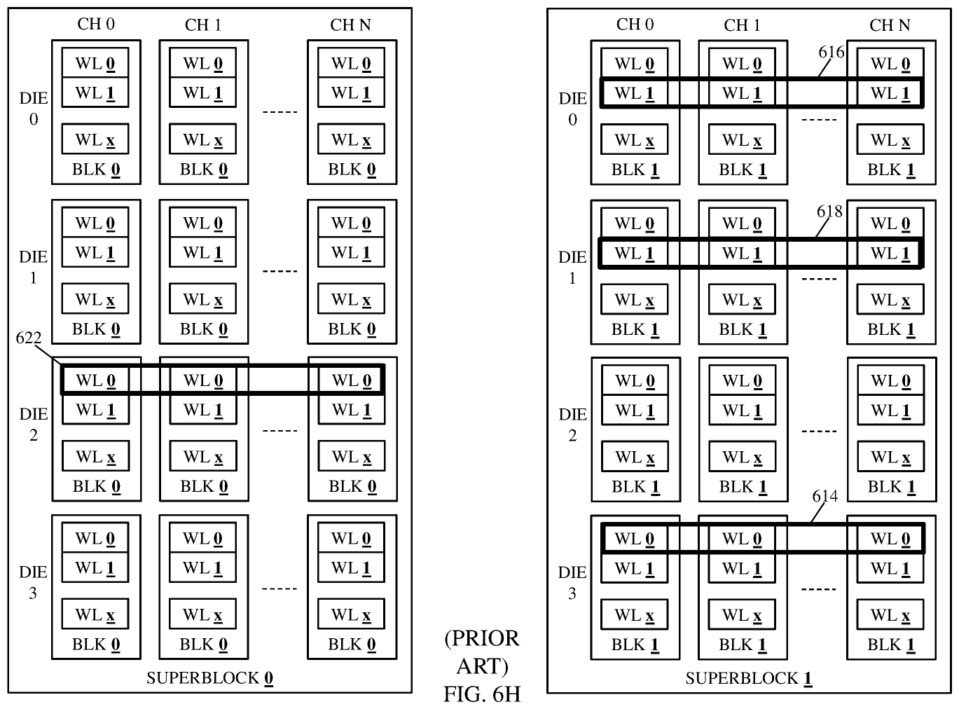

Referring now to FIGS. 6A, 6B, 6C, 6D, 6E, 6F, 6G, and 6H, an embodiment of conventional multi-superblock storage operation die collisions is illustrated. In the example provided below, a pair of superblocks 0 and 1 are provided by blocks 0 and 1, respectively, in the same four die 0, 1, 2, and 3 (each with corresponding channels 0-N) in a storage subsystem, and one of skill in the art in possession of the present disclosure will appreciate how FIGS. 6A-6H provides a greatly simplified example in order to illustrate the occurrence of die collisions. In the examples below, program/write storage operations for the superblocks 0 and 1 are performed in a 1:3 ratio (e.g., three program/write storage operations for superblock 1 for every one program/write storage operations for superblock 0) to provide a write amplification of 4. In other words, a first iteration of program/write storage operations is performed as superblock 0-superblock 1-superblock 1-superblock 1, a second iteration of program/write storage operations is performed as superblock 0-superblock 1-superblock 1-superblock 1, and so on.

For example, FIG. 6A illustrates a first superblock 0 window in which program/write storage operations 600 are performed on wordlines 0 of blocks 0 in the die 0/channels 0-N combinations that provide superblock 0 in response to a first superblock 0 program/write storage operation request. FIG. 6B illustrates a first superblock 1 window that includes a first superblock 1 program/write storage operation request to perform program/write storage operations 602 on wordlines 0 of blocks 1 in the die 0/channels 0-N combinations that provide superblock 1, program/write storage operations 604 on wordlines 0 of blocks 1 in the die 1/channels 0-N combinations that provide superblock 1, and program/write storage operations 606 on wordlines 0 of blocks 1 in the die 2/channels 0-N combinations that provide superblock 1, and the program/write storage operations 602 requested in that first superblock 1 program/write storage operation request cause a die collision and are blocked (as indicated by element 608) because the program/write storage operations 600 are currently being performed in the die 0 as discussed above. FIG. 6C illustrates how, following the completion of the program/write storage operations 600, the program/write storage operations 602 requested in the first superblock 1 program/write storage operation request will no longer be blocked, and the first superblock 1 window will be performed in which the program/write storage operations 602 are performed on wordlines 0 of blocks 1 in the die 0/channels 0-N combinations that provide superblock 1, the program/write storage operations 604 are performed on wordlines 0 of blocks 1 in the die 1/channels 0-N combinations that provide superblock 1, and the program/write storage operations 606 are performed on wordlines 0 of blocks 1 in the die 2/channels 0-N combinations that provide superblock 1 (thus providing the write amplification of 4 with three superblock 1 program/write storage operations for the one superblock 0 operation).

Continuing this example, FIG. 6D illustrates a second superblock 0 window that includes a second superblock 0 program/write storage operation request to perform program/write storage operations 610 on wordlines 0 of blocks 0 in the die 1/channels 0-N combinations that provide superblock 0, and the program/write storage operations 610 in that second superblock 0 program/write storage operation request cause a die collision and are blocked (as indicated by element 612) because the program/write storage operations 604 are currently being performed in the die 1 as discussed above. FIG. 6E illustrated how, following the completion of the program/write storage operations 604, the program/write storage operations 610 in the second superblock 0 program/write storage operation request will no longer be blocked, and the second superblock 0 window will be performed in which the program/write storage operations 610 are performed on wordlines 0 of blocks 0 in the die 1/channels 0-N combinations that provide superblock 0.

FIG. 6F illustrates a second superblock 1 window that includes a second superblock 0 program/write storage operation request to perform program/write storage operations 614 on wordlines 0 of blocks 1 in the die 3/channels 0-N combinations that provide superblock 1, program/write storage operations 616 on wordlines 1 of blocks 1 in the die 0/channels 0-N combinations that provide superblock 1, and program/write storage operations 618 on wordlines 1 of blocks 1 in the die 1/channels 0-N combinations that provide superblock 1, and the program/write storage operations 618 in the second superblock 1 program/write storage operation request cause a die collision and are blocked (as indicated by element 620) because the program/write storage operations 610 are currently being performed in the die 1 as discussed above. FIG. 6G illustrates how, following the completion of the program/write storage operations 610, the program/write storage operations 618 in the second superblock 1 program/write storage operation request will no longer be blocked, and the second superblock 1 window will be performed in which the program/write storage operations 614 are performed on wordlines 0 of blocks 1 in the die 3/channels 0-N combinations that provide superblock 1, the program/write storage operations 616 are performed on wordlines 1 of blocks 1 in the die 0/channels 0-N combinations that provide superblock 1, and the program/write storage operations 618 are performed on wordlines 1 of blocks 1 in the die 1/channels 0-N combinations that provide superblock 1 (thus providing the write amplification of 4 with three superblock 1 program/write storage operations for the one superblock 0 operation).

FIG. 6H illustrates a third superblock 0 window in which program/write storage operations 622 are performed on wordlines 0 of blocks 0 in the die 2/channels 0-N combinations that provide superblock 0 in response to a third superblock 0 program/write storage operation request, and one of skill in the art in possession of the present disclosure will appreciate how the program/write storage operations 620 may be performed while the program/write storage operations 614, 616, and 618 are performed as no die collision is present. Furthermore, one of skill in the art in possession of the present disclosure will appreciate how the program/write storage operations and die collisions described above will occur periodically until the superblocks 0 and 1 are completely programmed/written. However, while specific examples of die collisions are illustrated and discussed in FIGS. 6A-6H, one of skill in the art in possession of the present disclosure will appreciate how die collisions may result from other scenarios and may occur across multiple open superblocks, at different rates than those illustrated, and can result in storage operation delays that vary in a variety of manners.

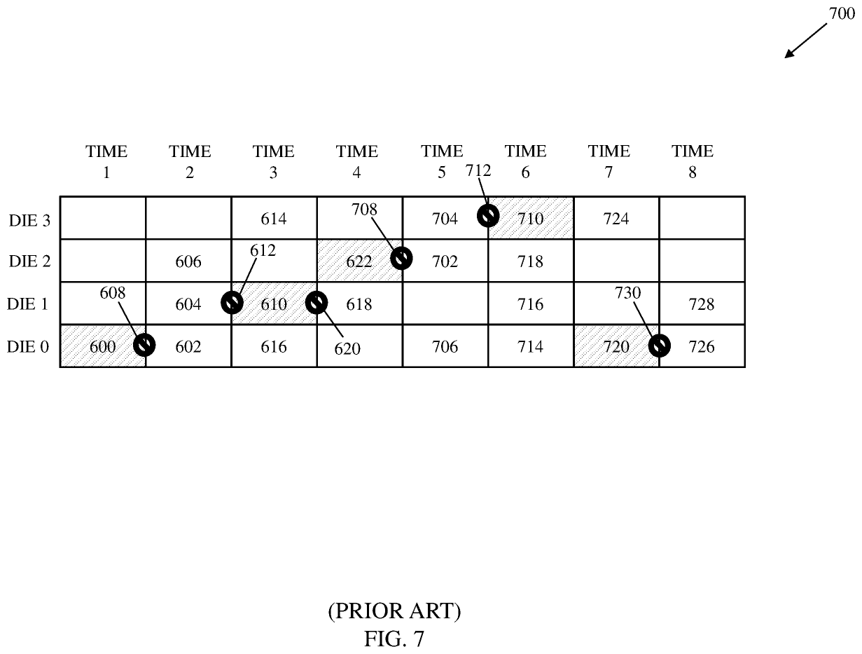

For example, FIG. 7 illustrates a die collision table 700 that continues the example provided in FIGS. 6A-6H above, with each box in the die collision table 700 representing a program/write window, with the superblock 0 program/write storage operations in program/write windows shaded, and with the superblock 1 program/write storage operations in program/write windows not shaded. As can be seen in FIG. 7, the superblock 0 program/write storage operations 600, 610, and 622, the superblock 1 program/write storage operations 602, 604, 606, 614, 616, and 618, and the die collisions 608, 612, and 620 discussed above are identified in the die collision table 700. Furthermore, additional superblock 0 program/write storage operations 710 and 720, additional superblock 1 program/write storage operations 702, 704, 706, 714, 716, 718, 724, 726, and 728, and additional die collisions 708, 712, and 730, are identified in the die collision table 700 for four additional time windows 5-8. As such, the die collisions result in a die utilization rate that may be calculated as a ratio of program-write windows used/program-write windows available (i.e., program-write windows in which a program-write was performed/total program-write windows in the die collision table 700), with the simplified example in FIG. 7 providing a die utilization rate of ( 21/28=) 75%. Furthermore, the inventors of the present disclosure have utilized more complicated/real-world examples that have resulted in a die utilization rate closer to 67%. As will be appreciated by one of skill in the art in possession of the present disclosure, the die collisions and lower die utilization rate reduce the performance of the storage device.

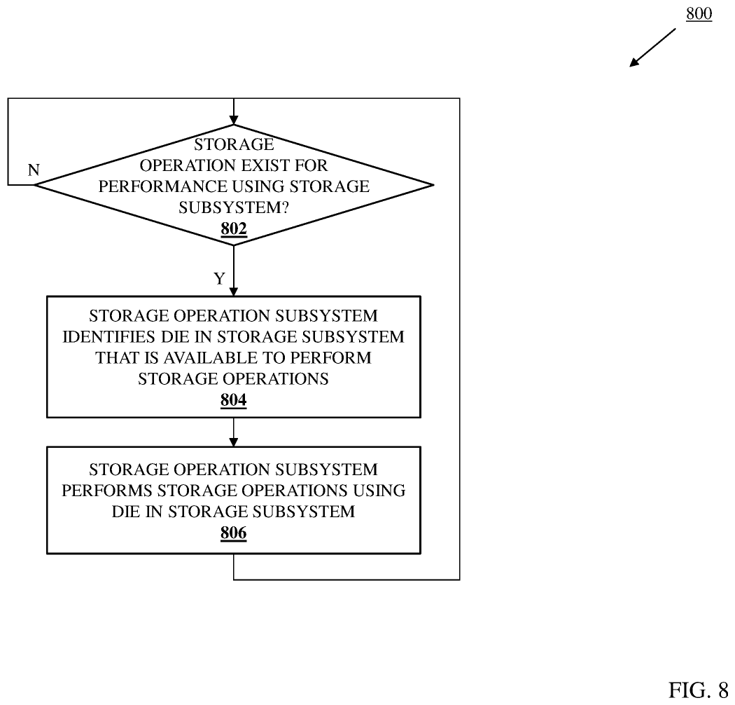

Referring now to FIG. 8, an embodiment of a method 800 for avoiding die collisions when performing storage operations in a storage subsystem is illustrated. As discussed below, the systems and methods of the present disclosure provide for the performance of storage operations on any idle die in storage system without the use of a fixed die storage operation order, thus performing those storage operations in a random “greedy’ die storage operation order that utilizes any die that is currently available to perform storage operations. For example, the storage operation die collision avoidance system of the present disclosure may include a storage subsystem providing a first superblock and a second superblock. A storage operation subsystem is coupled to the storage subsystem and performs first storage operations for the first superblock using a first die in the storage subsystem. The storage operation subsystem then determines second storage operations for performance for the second superblock and, without a fixed die storage operation order, identifies a second die in the storage subsystem that is available to perform the second storage operations for the second superblock while at least some of the first storage operations are performed for the first superblock using the first die in the storage subsystem. The storage operation subsystem then performs the second storage operations for the second superblock using the second die in the storage subsystem. As such, storage operations for different superblocks provided by a storage subsystem may be performed via the selection of idle die in any order that prioritizes avoiding die collisions, thus increasing the die utilization rate and performance of the storage device.

As discussed in further detail below, the identification of die in the storage subsystem for use in performing storage operations may also include identifying die in the storage subsystem that are currently be utilized to perform storage operations, but that will be idle within a threshold time period (e.g., the die that will be idle soonest). As will be appreciated by one of skill in the art in possession of the present disclosure in the art in possession of the present disclosure, storage subsystem efficiency may be increased by maximizing die usage, and thus in situations where all die are currently being utilized to perform first storage operations and a second storage operation is requested, the next available die may be identified for use in performing those second storage operations. As also discussed in further detail below, the random “greedy” die storage operation order that results from the techniques of the present disclosure could result in the utilization of particular blocks more than others, and thus the identification of die in the storage subsystem for use in performing storage operations may also include identifying first die in the storage subsystem that have been used less frequently than second die in the storage subsystem, and utilizing those die to perform storage operations in order to balance the utilization of die for performing storage operations in the storage subsystem. As such, the random-die-identification techniques and idle-die-prediction techniques described below may operate to increase storage subsystem performance, while the die-usage-balancing techniques described below may operate to prevent negative side effects (e.g., die wordline depletion) that may result from the random-die-identification techniques and idle-die-prediction techniques.

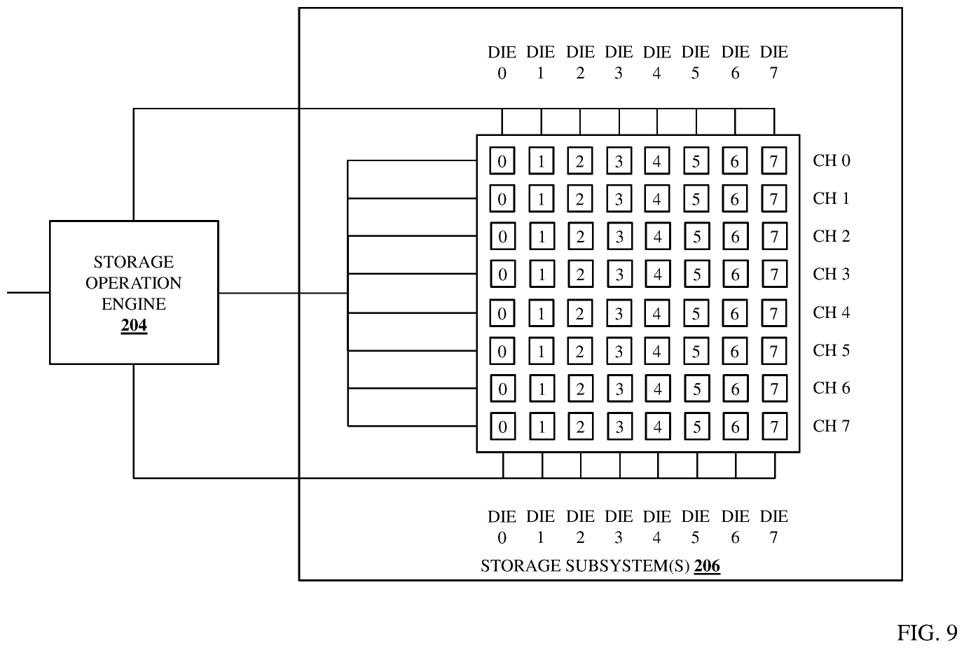

With reference to FIG. 9, an embodiment of portions of the storage device 200 discussed above with reference to FIG. 2 are illustrated. In the illustrated embodiment, the storage operation engine 204 in the storage device 200 of FIG. 2 is illustrated as coupled to the storage subsystem(s) 206 in the storage device 200, with the storage subsystem(s) 206 including eight die (die 0-7) and 8 corresponding channels (channels 0-7). Furthermore, multiple blocks are provided at each die/channel combination, with blocks 0 provided at the die 0/channel 0 combination, blocks 1 provided at the die 1/channel 0 combination, etc.

A first iteration of the method 800 begins at decision block 802 where it is determined whether first storage operations exist for performance using a storage system. In an embodiment, in this first iteration of the method 800 and at decision block 802, the storage operation engine 204 in the storage device 200 may monitor to determine whether first storage operations exist for performance using the storage subsystem(s) 206. As discussed below, first storage operations for performance using the storage subsystem(s) 206 may be instructed by a host system, and thus the storage operation engine 204 in the storage device 200 may monitor for the receipt of such instructions at decision block 802. As also discussed below, first storage operations for performance using the storage subsystem(s) 206 may exist without having been instructed by a host system (e.g., a Central Processing Unit (CPU) in a computing device that includes the storage device 200), and thus the storage operation engine 204 in the storage device 200 may monitor for the existence of such first storage operations at decision block 802 as well. However, while two specific examples of first storage operations that exist for performance using a storage subsystem have been described, one of skill in the art in possession of the present disclosure will appreciate that the existence of any storage operations for performance using a storage subsystem may be monitored for at decision block 804 while remaining within the scope of the present disclosure as well. If, during this first iteration of the method 800 and at decision block 802, it is determined that first storage operations do not exist for performance using the storage system(s) 206, the method 800 returns to decision block 802. As such, the first iteration of the method 800 may loop such that the storage operation engine 204 in the storage device 200 continues to monitor for the existence of first storage operations for performance using the storage subsystem(s) 206 until such first storage operations exist.

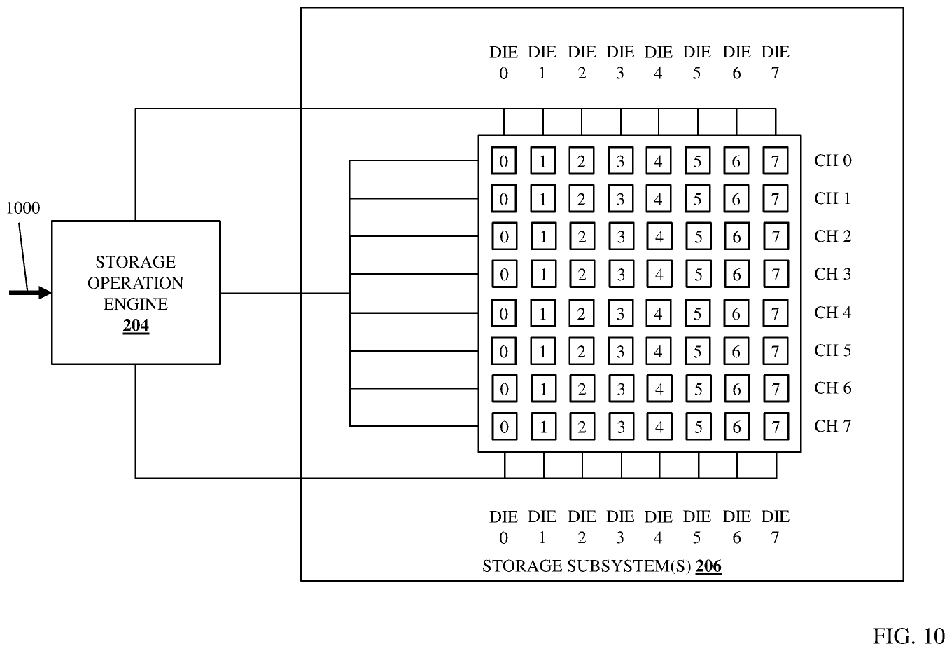

If, during this first iteration of the method 800 and at decision block 802, it is determined that first storage operations exist for performance using the storage subsystem(s), the first iteration of the method 800 proceeds to block 804 where the storage operation subsystem identifies a die in the storage subsystem that is available to perform those first storage operations. With reference to FIG. 10, in an embodiment of this first iteration of the method 800 and at decision block 802, the storage operation engine 204 in the storage device 200 may perform first storage operation instruction receiving operations 1000 that include receiving a first storage operations instruction (e.g., from a host system such as a CPU in a server device or other computing device known in the art) that instructs the performance of first storage operations for a first superblock. In different embodiments, the first storage operations instruction received at decision block 802 may instruct a program/write storage operation, an erase storage operation, and/or any other first storage operations for the first superblock that would be apparent to one of skill in the art in possession of the present disclosure. Furthermore, while the storage operation engine 204 is described as determining the first storage operations exists for performance using the storage subsystem(s) 206 at this first iteration of decision block 802 in response to receiving a first storage operations instruction for a first superblock, one of skill in the art in possession of the present disclosure will recognize that the storage operation engine 204 may determine that the first storage operations exist for performance for the first superblock using the storage subsystem(s) 206 without receiving a first storage operations instruction. For example, the storage operation engine 204 in the storage device 200 may determine that garbage collection/recycle storage operations and/or other first storage operations should be performed for the first superblock using the storage subsystem(s) 206 at decision block 802 without receiving a first storage operations instruction while remaining within the scope of the present disclosure as well.

In an embodiment of this first iteration of the method 800, at block 804 and in response to receiving the first storage operations instruction for the first superblock, the storage operation engine 204 in the storage device may identify that die 1 in the storage subsystem(s) 206 is available to perform the first storage operations determined at decision block 802 for the first superblock. As will be appreciated by one of skill in the art in possession of the present disclosure, the storage operation engine 204 in the storage device 200 may be configured to identify whether storage operations are currently being performed using any of the die 0-7 in the storage subsystem(s) 206 such that those die are “busy” die, as well as to identify whether storage operations are not currently being performed using any of the die 0-7 in the storage subsystem(s) 206 such that those die are “idle” die.

For example, as discussed in further detail below, the storage operation engine 204 in the storage device 200 is configured to monitor the state of each die. One of skill in the art in possession of the present disclosure will appreciate how a die state cycle for a die may begin with an idle state, and once a storage operation request is sent to the die, that die will enter an active state. As discussed below, die in an active state may have their storage operations suspended so that they enter a suspended state, and may then again enter the active state when those storage operations are resumed. When a storage operation on a die is completed, the NAND device in that die will transmit a completion request that causes the die to again enter the idle state. As such, the storage operation engine 204 in the storage device 200 may monitor the state of each die to identify when die enter the active state, the progress of that active state, and when that die again enters the idle state. As also discussed below, the storage operation engine 204 in the storage device 200 may continuously monitor the die and collect information in order to allow it to estimate how “close” a die in an active state is to entering the idle state.

As such, one of skill in the art in possession of the present disclosure will appreciate how, during this first iteration of the method 800 and at block 804, the storage operation engine 204 in the storage device 200 may identify any idle die in the storage subsystem(s) 206 that are available to perform the first storage operation determined at decision block 802 for the first superblock. Furthermore, as discussed in further detail below with reference to the method 1500, in some embodiments the identification of a die in the storage subsystem(s) 206 that is available to perform a storage operation determined at decision block 802 for a superblock may include identifying that a “busy” die will soon be an “idle” die, and then identifying that “busy-but-soon-to-be-idle” die as being available to perform the storage operation at block 804.

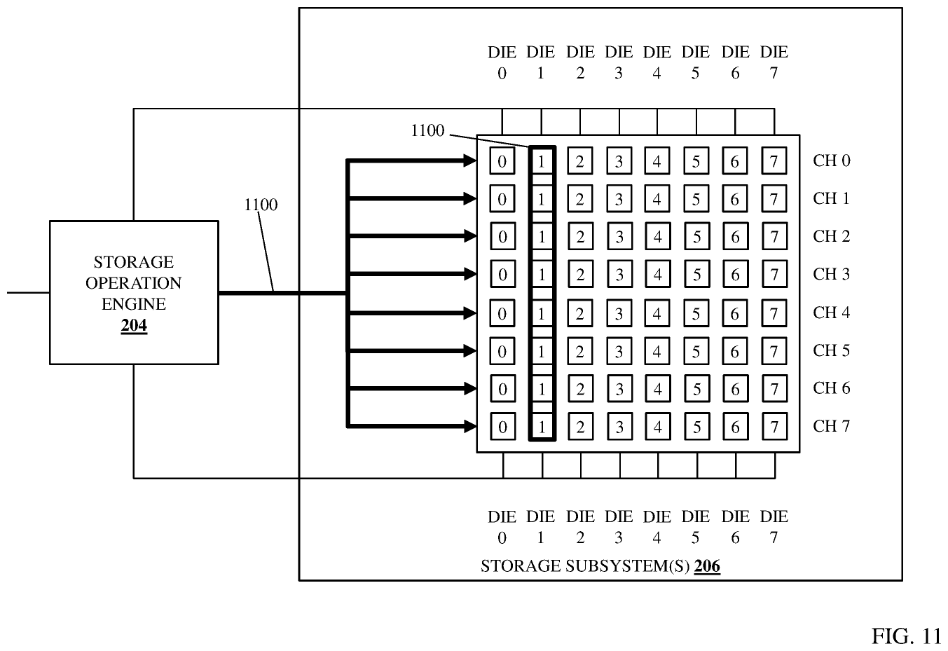

This first iteration of the method 800 then proceeds to block 806 where the storage operation subsystem performs the first storage operations using the storage subsystem. With reference to FIG. 11, in an embodiment of this first iteration of the method 800 and at block 806, the storage operation engine 204 in the storage device 200 may perform first storage operations execution operations 1100 that include executing the first storage operations instruction received at decision block 802 to perform the first storage operations for the first superblock using the die 1 in the storage subsystem 206. However, as discussed above, the storage operation engine 204 in the storage device 200 may identify that the die 1 in the storage subsystem(s) 206 is available to perform first storage operations at block 804 in response to determining that first storage operations should be performed for the first superblock without receiving a corresponding first storage operations instruction and, thus, the storage operation engine 204 may perform the first storage operation execution operations 1100 without receiving an instruction to do so from a host system while remaining within the scope of the present disclosure as well.

The method 800 then returns to decision block 802. In this second iteration of the method 800, at decision block 802 it is determined whether second storage operations exist for performance using the storage subsystem(s) 206 while the first storage operations are performed using die 1 in the storage subsystem(s) 206 as per the first iteration of the method 800 described above. In an embodiment, in this second iteration of the method 800 and at decision block 802, the storage operation engine 204 in the storage device 200 may monitor to determine whether second storage operations exist for performance using the storage subsystem(s) 206. Similarly as discussed above, second storage operations for performance using the storage subsystem(s) 206 may be instructed by a host system, and thus the storage operation engine 204 in the storage device 200 may monitor for the receipt of such instructions at decision block 802. As also discussed above, second storage operations for performance using the storage subsystem(s) 206 may exist without having been instructed by a host system, and thus the storage operation engine 204 in the storage device 200 may monitor for the existence of such second storage operations at decision block 802 as well. However, while two specific examples of storage operations that exist for performance using a storage subsystem have been described, one of skill in the art in possession of the present disclosure will appreciate that the existence of any storage operations for performance using a storage subsystem may be monitored for at decision block 802 while remaining within the scope of the present disclosure as well. If, during this second iteration of the method 800 and at decision block 802, it is determined that second storage operations do not exist for performance using the storage system(s) 206, the method 800 returns to decision block 802. As such, the second iteration of the method 800 may loop such that the storage operation engine 204 in the storage device 200 continues to monitor for the existence of second storage operations for performance using the storage subsystem(s) 206, while performing the first storage operations as per the first iteration of the method 800 described above, until such second storage operations exist.

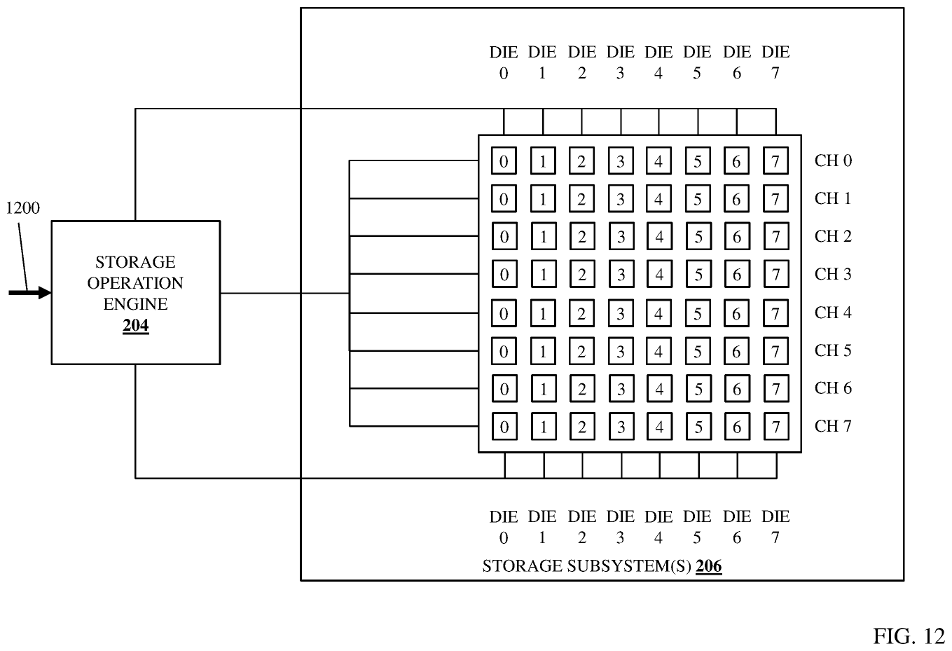

If, during this second iteration of the method 800 and at decision block 802, it is determined that second storage operations exist for performance using the storage subsystem(s), the second iteration of the method 800 proceeds to block 804 where the storage operation subsystem identifies a die in the storage subsystem that is available to perform those second storage operations. With reference to FIG. 12, in an embodiment of this second iteration of the method 800 at decision block 802, the storage operation engine 204 in the storage device 200 may perform second storage operations instruction receiving operations 1200 that include receiving a second storage operations instruction (e.g., from a host system such as a CPU in a server device or other computing device known in the art) that instructs the performance of second storage operations for a second superblock. Similarly as described above, the second storage operation instruction received at decision block 802 may instruct a program/write storage operation, an erase storage operation, and/or any other second storage operations for the second superblock that would be apparent to one of skill in the art in possession of the present disclosure. Furthermore, while the storage operation engine 204 is described as determining the second storage operations exists for performance using the storage subsystem(s) 206 at this second iteration of decision block 802 in response to receiving a second storage operations instruction for a second superblock, one of skill in the art in possession of the present disclosure will recognize that the storage operation engine 204 may determine that the second storage operations exist for performance for the second superblock using the storage subsystem(s) 206 without receiving a second storage operations instruction. For example, the storage operation engine 204 in the storage device 200 may determine that garbage collection/recycle storage operations and/or other storage operations should be performed for the second superblock using the storage subsystem(s) 206 at decision block 802 without receiving a second storage operations instruction while remaining within the scope of the present disclosure as well.

In an embodiment of this second iteration of the method 800, at block 804 and in response to receiving the second storage operations instruction for the second superblock, the storage operation engine 204 in the storage device may identify that die 7 in the storage subsystem(s) 206 is available to perform the second storage operations determined at decision block 802 for the second superblock. Similarly as discussed above, the storage operation engine 204 in the storage device 200 may be configured to identify whether storage operations are currently being performed using any of the die 0-7 in the storage subsystem(s) 206 such that those die are “busy” die, as well as to identify whether storage operations are not currently being performed using any of the die 0-7 in the storage subsystem(s) 206 such that those die are “idle” die. As such, one of skill in the art in possession of the present disclosure will appreciate how, during this second iteration of the method 800 and at block 804, the storage operation engine 204 in the storage device 200 may identify any idle die in the storage subsystem(s) 206 that are available to perform the second storage operations determined at decision block 802 for the second superblock. Furthermore, as discussed in further detail below with reference to the method 1500, in some embodiments the identification of a die in the storage subsystem(s) 206 that is available to perform storage operations determined at decision block 802 for a superblock may include identifying that a “busy” die will soon be an “idle” die, and then identifying that “busy-but-soon-to-be-idle” die as available to perform the storage operation at block 804.

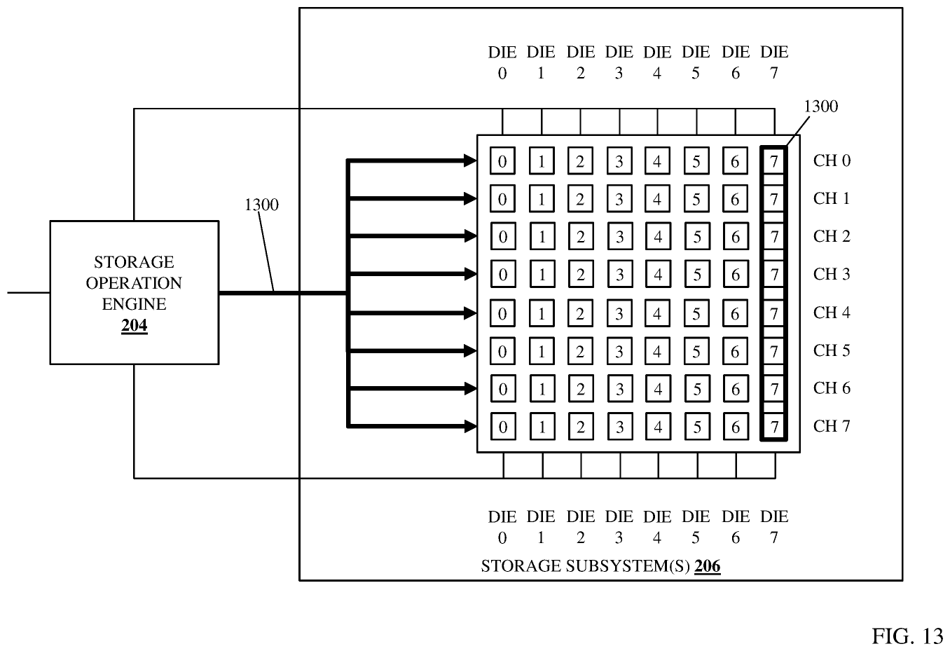

This second iteration of the method 800 then proceeds to block 806 where the storage operation subsystem performs the second storage operations using the storage subsystem. With reference to FIG. 13, in an embodiment of this second iteration of the method 800 and at block 806, the storage operation engine 204 in the storage device 200 may perform second storage operations execution operations 1300 that include executing the second storage operations instruction received at decision block 802 to perform the second storage operations for the second superblock using the die 7 in the storage subsystem 206. However, as discussed above, the storage operation engine 204 in the storage device 200 may identify that the die 7 in the storage subsystem(s) 206 is available to perform second storage operations at block 804 in response to determining that second storage operations should be performed for the second superblock without receiving a corresponding second storage operations instruction and, thus, the storage operation engine 204 may perform the second storage operations execution operations 1300 without receiving an instruction to do so from a host system while remaining within the scope of the present disclosure as well. The method 800 may then return to decision block 802, and one of skill in the art in possession of the present disclosure will recognize how the method 800 may continue to loop through blocks 802, 804, and 806 similarly as described above as storage operations are subsequently determined to exist for performance using the storage subsystem(s) 206.

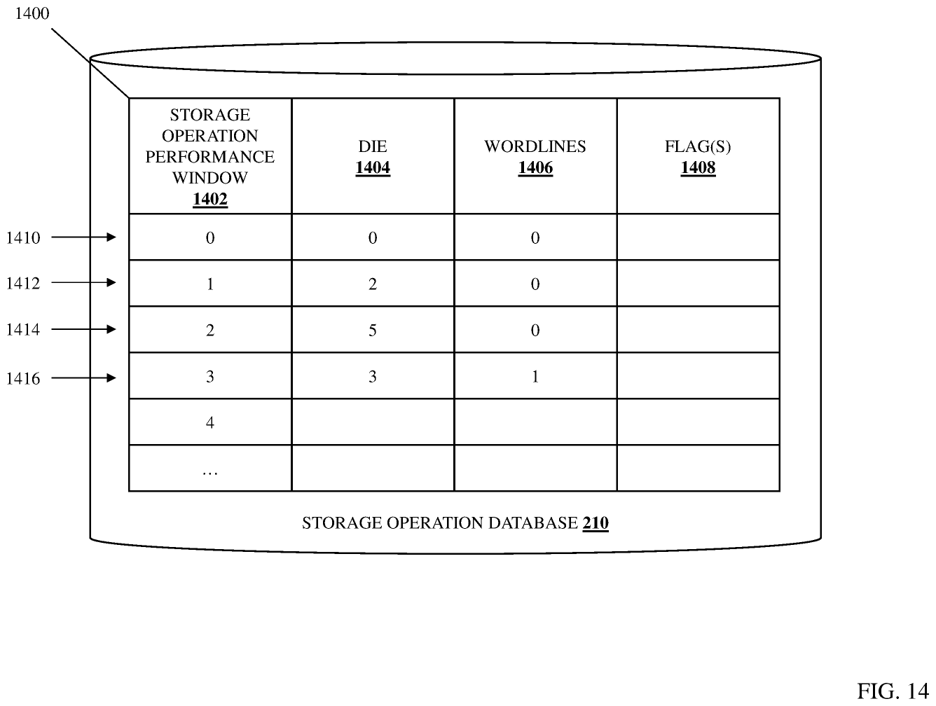

With references to FIG. 14, an embodiment of a die program/write storage operation order tracking table 1400 is illustrated that may be generated, maintained, and/or otherwise provided by the storage operation engine 204 in the storage operation database 210 during the method 800. In an embodiment, a die program/write storage operation order tracking table like the die program/write storage operation order tracking table 1400 illustrated in FIG. 14 may be provided for each superblock provided by a storage subsystem, and may be generated during the programming/writing of that superblock, while being accessible until that superblock is “reclaimed”. Furthermore, while described as being stored in the storage operation database 210, one of skill in the art in possession of the present disclosure will appreciate how the die program/write storage operation order tracking table 1400 may be stored in other locations (e.g., in the superblock it was generated for), may be stored as redundant copies in multiple locations, and/or may be stored in a variety of other manners that would be apparent to one of skill in the art in possession of the present disclosure.

As can be seen in the example illustrated in FIG. 14, the die program/write storage operation order tracking table 1400 includes a storage operation performance window column 1402, a die column 1404, a wordlines column 1406, and a flag(s) column 1408. As will be appreciated by one of skill in the art in possession of the present disclosure, each row of the die storage operation order tracking table 1400 may store information about a program/write storage operation performed in the storage subsystem(s) 206, with the storage operation performance window column 1402 identifying a “relative time window” in which the program/write occurred, the die column 1404 identifying the die to which data was written, the wordlines column 1406 identifying the wordlines in the die to which data was written, and the flag(s) column 1408 available to indicate information about the data that was written (e.g., whether the data that was written includes parity/XOR data, reverse log page data, etc.).

For example, in the specific embodiment illustrated in FIG. 14, a row 1410 of the die program/write storage operation order tracking table 1400 stores information about a program/write storage operation that wrote data to wordlines 0 (identified in the wordlines column 1406 for row 1410) in die 0 (identified in the die column 1404 for row 1410) of the storage subsystem(s) 206 during a storage operation performance window 0 (identified in the storage operation performance window column 1402 for row 1410) Similarly, a row 1412 of the die program/write storage operation order tracking table 1400 stores information about a program/write storage operation that wrote data to wordlines 0 in die 2 of the storage subsystem(s) 206 during a storage operation performance window 1, a row 1414 of the die program/write storage operation order tracking table 1400 stores information about a program/write storage operation that wrote data to wordlines 0 in die 5 of the storage subsystem(s) 206 during a storage operation performance window 2, and a row 1416 of the die program/write storage operation order tracking table 1400 stores information about a program/write storage operation that wrote data to wordlines 1 in die 3 of the storage subsystem(s) 206 during a storage operation performance window 3. Furthermore, one of skill in the art in possession of the present disclosure will appreciate how the die program/write storage operation order tracking table 1400 may be used to track any other program/write storage operations for the storage subsystem(s) 206 while remaining within the scope of the present disclosure as well.

As will be appreciated by one of skill in the art in possession of the present disclosure, the method 800 allows data to be written to any die in the storage subsystem(s) 206 randomly, and the die program/write storage operation order tracking table 1400 operates to maintain a chronology of the program/write storage operation order, which may be subsequently used to identify and retrieve parity/XOR data during data rebuild operations, determine the location of a reverse log page for a superblock that enables the locating of logical addresses when given corresponding physical addresses, identify valid/invalid data when performing garbage collection/recycle operations, as well as other uses that would be apparent to one of skill in the art in possession of the present disclosure.

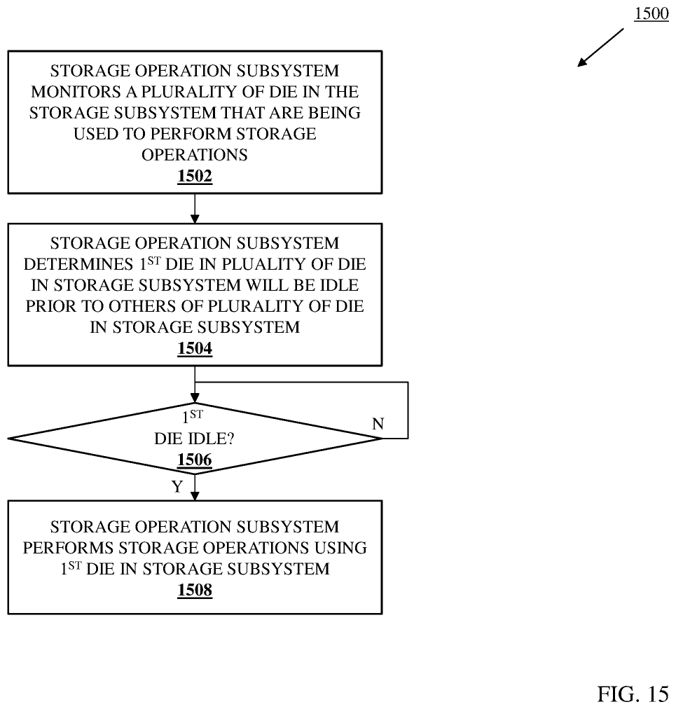

With reference to FIG. 15, an embodiment of a method 1500 for identifying an idle die during the method 800 of FIG. 8 is illustrated. As discussed above, the identification of die in the storage subsystem for use in performing storage operations may also include identifying die in the storage subsystem that are currently be utilized to perform storage operations, but that will be idle within a threshold time period. As will be appreciated by one of skill in the art in possession of the present disclosure, the efficiency of the storage subsystems and storage devices of the present disclosure may be increased by maximizing die usage, and thus in situations where all die are currently being utilized to perform first storage operations and a second storage operation is requested, the next available die may be identified for use in performing those second storage operations using the techniques discussed below. As such, one of skill in the art in possession of the present disclosure will appreciate how the methods 800 and 1500 may be performed by the storage operation engine 204 in the storage device 200 at the same time, and while the method 1500 is described as being partially integrated with the method 800 in a particular manner, the methods 800 and 1500 may be performed in other manners that will fall within the scope of the present disclosure as well.

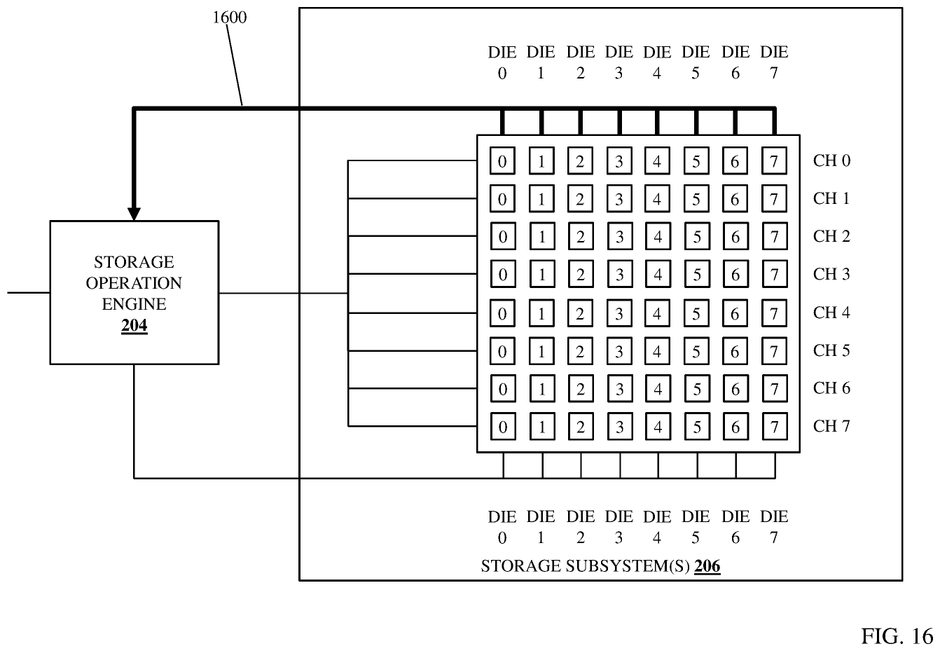

In an embodiment, the method 1500 begins at block 1502 where the storage operation subsystem monitors a plurality of die in the storage subsystem that are being used to perform storage operations. With reference to FIG. 16, in an embodiment of block 1502, the storage operation engine 204 in the storage device 200 may perform die monitoring operations 1600 that include monitoring storage operations being perform using the die 0-7 in the storage subsystem(s) 206. Furthermore, while the examples below illustrated and describe the use of all of the die 0-7 in the storage subsystem(s) 206 for performing storage operations and thus the monitoring of all of those die 0-7, one of skill in the art in possession of the present disclosure will appreciate that other embodiments may include the monitoring of a subset of the die in the storage subsystem(s) 206 that are being used to perform storage operations (e.g., when the remaining subset of the die in the storage subsystem(s) 206 are not available for storage operations).

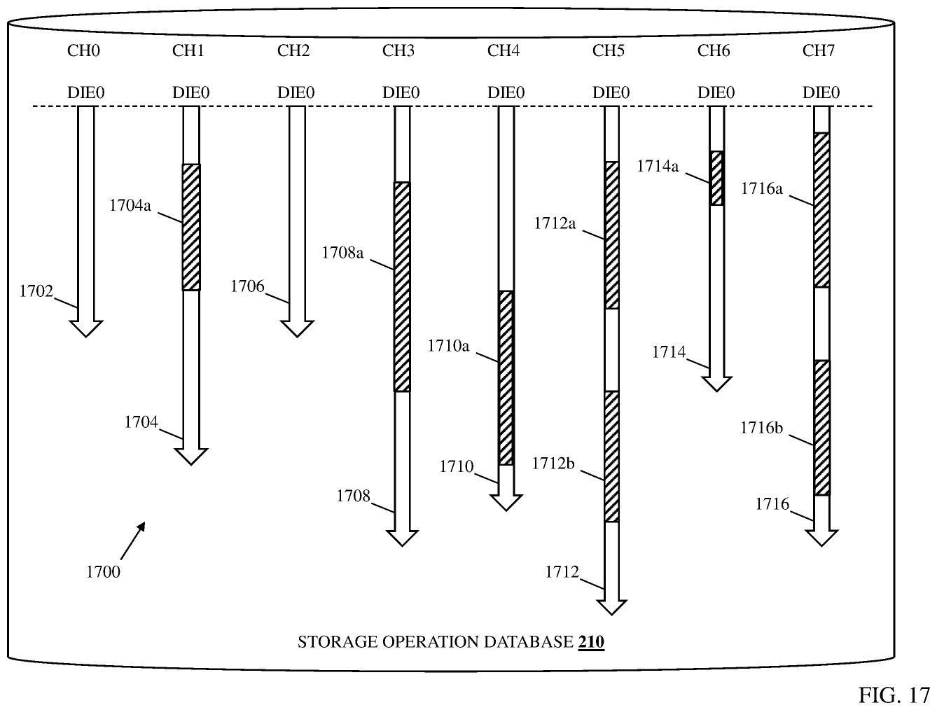

With reference to FIG. 17, an embodiment of the die monitoring operations 1600 is illustrated via a graphical representation of die monitoring data 1700 that may be generated and stored by the storage operation engine 204 in the storage operation database 210. In this example, the monitoring of the die 0 in the storage subsystem(s) 206 is illustrated, and one of skill in the art in possession of the present disclosure will appreciate how the other die in the storage subsystem(s) 206 may be monitored in a similar manner while remaining within the scope of the present disclosure as well. In the specific embodiment illustrated in FIG. 17, the die monitoring operations 1600 include monitoring the performance time of storage operations being performed at each channel 0-7 of the die 0 in the storage subsystem(s) 206, as well as the times associated with the suspension of any of those storage operations.

For example, the graphical representation of die monitoring data 1700 in FIG. 17 illustrates how the storage operations at the die 0/channel 0 combination may be performed for a time 1702, the storage operations at the die 0/channel 1 combination may be performed for a time 1704 with a suspension time of 1704a, the storage operations at the die 0/channel 2 combination may be performed for a time 1706, the storage operations at the die 0/channel 3 combination may be performed for a time 1708 with a suspension time of 1708a, the storage operations at the die 0/channel 4 combination may be performed for a time 1710 with a suspension time of 1710a, the storage operations at the die 0/channel 5 combination may be performed for a time 1712 with suspension times of 1712a and 1712b, the storage operations at the die 0/channel 6 combination may be performed for a time 1714 with a suspension time of 1714a, and the storage operations at the die 0/channel 7 combination may be performed for a time 1716 with suspension times of 1716a and 1716b.

In this specific embodiment, the die monitoring operations 1600 may include generating respective die monitoring data (similar to the die monitoring data 1700 discussed above) for each of the die 0-7, and using that die monitoring data to determine an amount of time remaining to complete the storage operations being performed on each die. For example, the time to complete storage operations using each die/channel combination may be assumed to be the same for the same types of storage operations (e.g., 2000 ms for program/write storage operations), and thus the time to complete the storage operations using the corresponding die may be estimated to provide an estimated storage operation completion time for that die (e.g., 8×2000 ms=16000 ms in the example provided above). The storage operation engine 204 in the storage device 200 may then also track suspension times for the storage operations that are performed using each die/channel combination in the die, and add the suspension times to the estimated storage operation completion time for the die. Finally, the storage operation engine 204 in the storage device 200 may compare an actual storage operation time for a die to its estimated storage operation completion time, which one of skill in the art in possession of the present disclosure will appreciate allows for an estimation of the amount of time remaining to complete the storage operations using that die. However, while specific die monitoring operations 1600 and die monitoring data 1700 have been illustrated and described, one of skill in the art in possession of the present disclosure will appreciate how “busy” die may be monitored to determine whether they will soon become available using other techniques that will fall within the scope of the present disclosure as well.

The method 1500 then proceeds to block 1504 where the storage operation subsystem determines the first die in the plurality of die in the storage subsystem that will be idle prior to others of the plurality of die in the storage subsystem. In an embodiment, at block 1504, the storage operation engine 204 in the storage device 200 may determine one of the die 0-7 in the storage subsystem(s) 206 that will become idle prior to the others of the die 0-7 based on the die monitoring operations 1600 discussed above. As discussed above, the storage operation engine 204 in the storage device 200 may operate to estimate the amount of time remaining to complete the storage operations using each of the die 0-7, and at block 1504 may determine the one of the die 0-7 associated with the lowest estimated amount of time remaining to complete its storage operations and, thus, the one of the die 0-7 that will be idle prior to the others of the die 0-7.

The method 1500 then proceeds to decision block 1506 where it is determined whether the first die is idle. In an embodiment, at decision block 1506, the storage operation engine 204 in the storage device 200 may monitor the die identified at block 1504 to determine whether that die is idle or otherwise available to perform storage operations that exist for performance using the storage subsystem(s) 206 as discussed above with regard to the method 800. If, at decision block 106, it is determined that the second die is not idle, the method 1500 returns to decision block 1506. As such, the method 1500 may loop such that the storage operation engine 204 in the storage device 200 continues to monitor the die identified at block 1504 to determine whether that die is idle until that die becomes idle. Furthermore, while waiting for the die identified at block 1504 to become idle, the storage operation engine 204 in the storage device 200 may prepare a storage operation instruction for that die, determine a time to transmit the storage operation performance instruction to the storage subsystem(s) 206, and/or perform other storage operation instruction preparations that one of skill in the art in possession of the present disclosure will appreciate may allow the storage operation for that die to be instructed as soon as the die becomes idle.

If at decision block 1506, it is determined that first die is idle, the method 1500 proceeds to block 1508 where the storage operation subsystem performs storage operations using the first die in the storage subsystem. In an embodiment, at block 1508 and in response to determining that the die identified at block 1504 is idle, the storage operation engine 204 in the storage device 200 may provide the storage operation instruction to the storage subsystem(s) 206 in order to cause the performance of the storage operation using that die. As such, die utilization in the storage subsystem(s) 206 may be improved by predicting when “busy” die will become “idle” die, and providing storage operation instructions for those die in a manner that minimizes the amount of time they remain idle die.

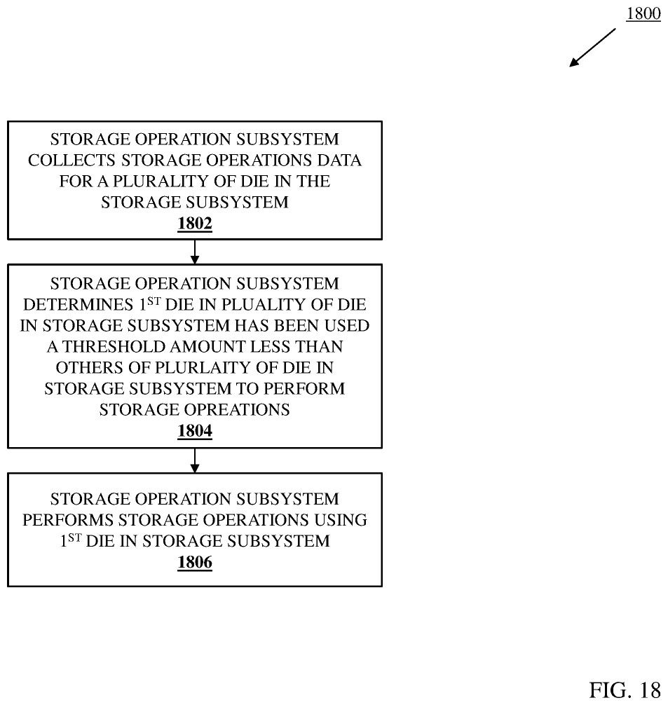

With reference to FIG. 18, an embodiment of a method 1800 for identifying die for use in performing storage operations during the method 800 of FIG. 8. As discussed above, the random “greedy” die storage operation order that results from the methods 800 and 1500 could result in the utilization of particular blocks in the storage subsystem(s) 206 more than others, and thus the identification of die in the storage subsystem(s) 206 for use in performing storage operations may also include identifying first die in the storage subsystem(s) 206 that have been used less frequently than second die in the storage subsystem(s) 206, and utilizing those die to perform storage operations in order to balance the utilization of die to perform storage operations in the storage subsystem(s) 206. As will be appreciated by one of skill in the art in possession of the present disclosure, skewness in the usage of die in a storage subsystem can lead to some die running out of wordlines before the programming/writing of data to superblocks has been completed, which can increase the chances of die collisions, and thus the method 1800 addresses die usage skewing by ensuring that no die in the storage subsystem is utilized more than a threshold amount less that the other die in the storage subsystem.

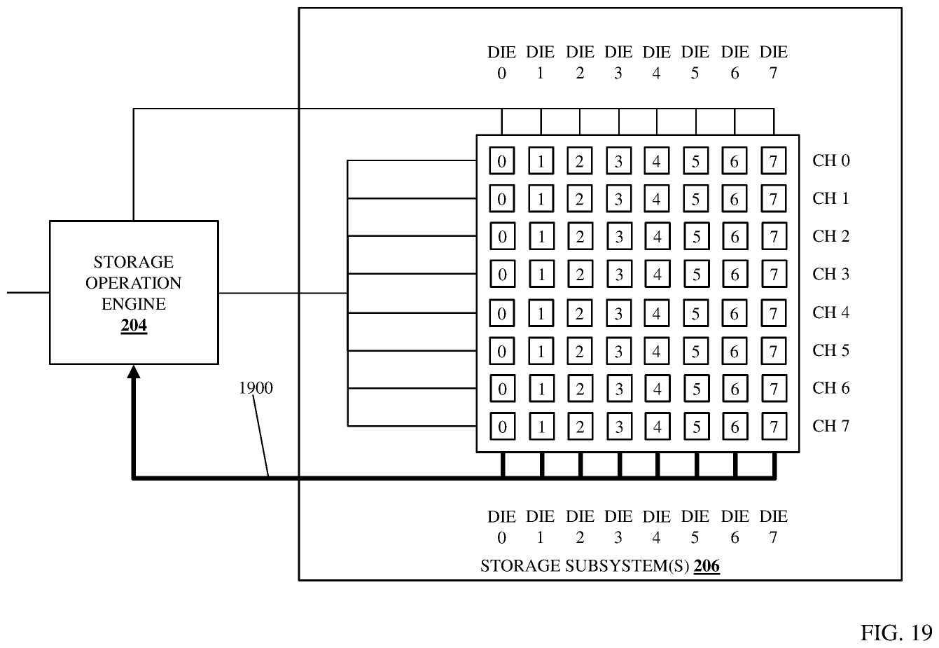

In an embodiment, the method 1800 begins at block 1802 where the storage operation subsystem collects storage operations data for a plurality of die in the storage subsystem. With reference to FIG. 19, in an embodiment of block 1802, the storage operation engine 204 in the storage device 200 may perform storage operation data collection operations 1900 that include collecting storage operation data generated in response to storage operations being perform using the die 0-7 in the storage subsystem(s) 206. Furthermore, while the examples below illustrated and describe the collection of storage operation data from all of the die 0-7 in the storage subsystem(s) 206, one of skill in the art in possession of the present disclosure will appreciate that other embodiments may include the collection of storage operation data from a subset of the die in the storage subsystem(s) 206 (e.g., when the remaining subset of the die in the storage subsystem(s) 206 are not available for storage operations).

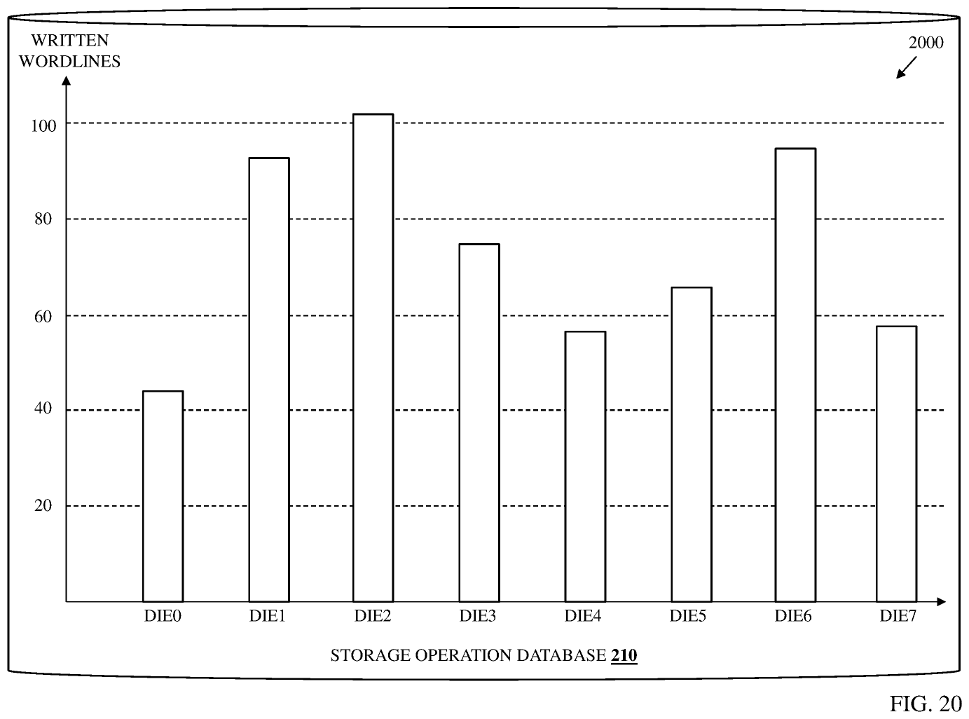

With reference to FIG. 20, an embodiment of the storage operation data collection operations 1900 is illustrated via a graphical representation of storage operation data 2000 that may be determined and/or collected and then stored by the storage operation engine 204 in the storage operation database 210. In this example, the collection of storage operation data for the die 0-7 in the storage subsystem(s) 206 is illustrated. In the specific embodiment illustrated in FIG. 20, the storage operation data collection operations 1900 include collecting storage operation data for each die 0-7 that includes a number of wordlines programmed/written in each die 0-7, but one of skill in the art in possession of the present disclosure will appreciate how other storage operation data may be collected or generated and may include a standard deviation of wordlines written for the die 0-7, a difference between a maximum number of wordlines written for the die 0-7 and a minimum number of wordlines written for the die 0-7, a total number of unwritten wordlines for any superblock provided by the die 0-7, as well as any other storage operation data that would be apparent to one of skill in the art in possession of the present disclosure. In the specific example illustrated in FIG. 20, the graphical representation of storage operation data 2000 illustrates how ˜45 wordlines have been written for die 0, ˜89 wordlines have been written for die 1, ˜101 wordlines have been written for die 2, ˜74 wordlines have been written for die 3, ˜57 wordlines have been written for die 4, ˜63 wordlines have been written for die 5, ˜93 wordlines have been written for die 6, and ˜59 wordlines have been written for die 7.

The method 1800 then proceeds to block 1804 where the storage operation subsystem determines a first die in the plurality of die in the storage subsystem that has been used a threshold amount less than others of the plurality of die in the storage subsystem to perform storage operations. In an embodiment, at block 1804, the storage operation engine 204 in the storage device 200 may analyze the storage operation data collected at block 1802 to determine whether one or more of the die 0-7 in the storage subsystem(s) 206 have been used a threshold amount less than the others of the die 0-7 in the storage subsystem(s) 206 to perform storage operations, and one of skill in the art in possession of the present disclosure will recognize how a variety of thresholds, different types of storage operation data, and different storage operation data analysis algorithms may be used to identify die in the storage subsystem(s) 206 that are candidates for the die-usage-balancing operations discussed below.

The method 1800 then proceeds to block 1806 where the storage operation subsystem performs the storage operation using the first die in the storage subsystem. In an embodiment, at block 1806 and in response to determining that the die determined at block 1804 has been used a threshold amount less than others of the plurality of die in the storage subsystem(s) 206, the storage operation engine 204 in the storage device 200 may provide the storage operation instruction to the storage subsystem(s) 206 in order to cause the performance of the storage operation using that die. As will be appreciated by one of skill in the art in possession of the present disclosure, the method 1800 ensures that die in the storage subsystem(s) 206 that have been used a threshold amount less than others of the plurality of die in the storage subsystem(s) 206 will be used in order to minimize skews in die usages within the storage subsystem(s) 206.

Furthermore, one of skill in the art in possession of the present disclosure will appreciate how the selection of die for performing storage operations based on those die having been utilized a threshold amount less than others of the plurality of die in the storage subsystem(s) 206 according to the method 1800 may result in the selection of die for die-usage-balancing purposes at the expense of the die utilization efficiency provided by the methods 800 and 1500. However, the use of the method 1800 will result in relatively even die usage within the storage subsystem(s) 206, thus allowing the die utilization efficiencies to be realized via the methods 800 and 1500 in most situations.

Thus, systems and methods have been described that provide for the avoidance of die collisions via the identification of die for performing storage operations without a fixed die storage operation order, and rather based on whether that die is idle. Furthermore, determinations on whether a die is idle may include determining whether the die will be idle relatively soon by monitoring the state of die in a storage subsystem and identifying the die for performing a most recently received storage operation if that die will be idle sooner than the rest of the die in the storage subsystem. Further still, die-usage-balancing may be performed on the die in the storage subsystem via the monitoring of storage operation data/statistics for the die in the storage subsystem, and selecting die for performing storage operations when those die have been used to perform storage operations a threshold amount less than the other die in the storage subsystem. As will be appreciated by one of skill in the art in possession of the present disclosure, the systems and methods of the present disclosure may be integrated with many existing/conventional storage device implementations via the reconfiguration of existing/conventional storage devices to perform the storage operation reordering and NAND operations monitoring discussed above.

As such, the systems and methods described herein improve die utilization in the storage subsystem, which increases storage device performance (e.g., by increasing bandwidth and reducing latency), saturates die usage in a manner that more fully utilizes available power in many storage device form factors (e.g., storage devices having the Enterprise and Data SSD Form Factor (EDSFF)), and results in other benefits that would be apparent to one of skill in the art in possession of the present disclosure. Furthermore, the inventors of the present disclosure expect the systems and methods described herein to provide relatively significant performance improvements in SSD storage devices supporting Zoned NameSpace (ZNS) functionality that programs/writes multiple superblocks at the same time.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A storage operation die collision avoidance system, comprising:
a storage subsystem;
a first superblock provided by the storage subsystem;
a second superblock provided by the storage subsystem; and
a storage operation subsystem that is coupled to the storage subsystem and that is configured to:
perform first storage operations for the first superblock using a first die in the storage subsystem;
determine second storage operations for performance for the second superblock;
identify, without a fixed die storage operation order, a second die in the storage subsystem that is available to perform the second storage operations for the second superblock while at least some of the first storage operations are performed for the first superblock using the first die in the storage subsystem; and
perform the second storage operations for the second superblock using the second die in the storage subsystem.

2. The system of claim 1, wherein the identifying the second die in the storage subsystem that is available to perform the second storage operations for the second superblock includes:
identifying the second die in the storage subsystem is being used to perform third storage operations; and
determining that the second die in the storage subsystem will be idle prior to a plurality of third die in the storage subsystem and, in response, identifying that the second die is available to perform the second storage operations for the second superblock.

3. The system of claim 2, wherein the performing the second storage operations for the second superblock using the second die in the storage subsystem includes:
determining that the third storage operations being performed using the second die in the storage subsystem have completed and, in response, performing the second storage operations for the second superblock using the second die in the storage subsystem.

4. The system of claim 1, wherein the storage operation subsystem is configured to:
identify the second die in the storage subsystem has been used less than a plurality of third die in the storage subsystem to perform storage operations and, in response, perform the second storage operations for the second superblock using the second die in the storage subsystem.

5. The system of claim 1, wherein the storage operation subsystem is configured to:
store, in second superblock table for the second superblock and in response to performing the second storage operations for the second superblock using the second die in the storage subsystem, an identifier for the second die in the storage subsystem in association with a storage operation performance window.

6. The system of claim 5, wherein the storage operation subsystem is configured to:
store, in the second superblock table for the second superblock in association with the storage operation performance window and in response to performing the second storage operations for the second superblock using the second die in the storage subsystem, an identifier for a wordline in the second die in the storage subsystem that was used to perform the second storage operations.

7. An Information Handling System (IHS), comprising:
a processing system; and
a memory system that is coupled to the processing system and that includes instructions that, when executed by the processing system, cause the processing system to provide a storage operation engine that is configured to:
perform first storage operations for a first superblock using a first die in a storage subsystem that provides the first superblock;
determine second storage operations for performance for a second superblock provided by the storage subsystem;
identify, without a fixed die storage operation order, a second die in the storage subsystem that is available to perform the second storage operations for the second superblock while at least some of the first storage operations are performed for the first superblock using the first die in the storage subsystem; and
perform the second storage operations for the second superblock using the second die in the storage subsystem.

8. The IHS of claim 7, wherein the identifying the second die in the storage subsystem that is available to perform the second storage operations for the second superblock includes:
identifying the second die in the storage subsystem is being used to perform third storage operations; and
determining that the second die in the storage subsystem will be idle prior to a plurality of third die in the storage subsystem and, in response, identifying that the second die is available to perform the second storage operations for the second superblock.

9. The IHS of claim 8, wherein the performing the second storage operations for the second superblock using the second die in the storage subsystem includes:
determining that the third storage operations being performed using the second die in the storage subsystem have completed and, in response, performing the second storage operations for the second superblock using the second die in the storage subsystem.

10. The IHS of claim 7, wherein the storage operation engine is configured to:
identify the second die in the storage subsystem has been used less than a plurality of third die in the storage subsystem to perform storage operations and, in response, perform the second storage operations for the second superblock using the second die in the storage subsystem.

11. The IHS of claim 7, wherein the storage operation engine is configured to:
store, in second superblock table for the second superblock and in response to performing the second storage operations for the second superblock using the second die in the storage subsystem, an identifier for the second die in the storage subsystem in association with a storage operation performance window.

12. The IHS of claim 11, wherein the storage operation engine is configured to:
store, in the second superblock table for the second superblock in association with the storage operation performance window and in response to performing the second storage operations for the second superblock using the second die in the storage subsystem, an identifier for a wordline in the second die in the storage subsystem that was used to perform the second storage operations.

13. The IHS of claim 7, wherein each of the first storage operations and the second operations include at least one of program operations or erase operations.

14. A method for avoiding die collisions when performing storage operations in a storage subsystem, comprising:
performing, by a storage operation subsystem, first storage operations for a first superblock using a first die in a storage subsystem that provides the first superblock;
determining, by the storage operation subsystem, second storage operations for performance for a second superblock provided by the storage subsystem;
identifying, by the storage operation subsystem without a fixed die storage operation order, a second die in the storage subsystem that is available to perform the second storage operations for the second superblock while at least some of the first storage operations are performed for the first superblock using the first die in the storage subsystem; and
performing, by the storage operation subsystem, the second storage operations for the second superblock using the second die in the storage subsystem.

15. The method of claim 14, wherein the identifying the second die in the storage subsystem that is available to perform the second storage operations for the second superblock includes:
identifying, by the storage operation subsystem, the second die in the storage subsystem is being used to perform third storage operations; and
determining, by the storage operation subsystem, that the second die in the storage subsystem will be idle prior to a plurality of third die in the storage subsystem and, in response, identifying that the second die is available to perform the second storage operations for the second superblock.

16. The method of claim 14, wherein the performing the second storage operations for the second superblock using the second die in the storage subsystem includes:
determining, by the storage operation subsystem, that the third storage operations being performed using the second die in the storage subsystem have completed and, in response, performing the second storage operations for the second superblock using the second die in the storage subsystem.

17. The method of claim 14, further comprising:
identifying, by the storage operation subsystem, the second die in the storage subsystem has been used less than a plurality of third die in the storage subsystem to perform storage operations and, in response, perform the second storage operations for the second superblock using the second die in the storage subsystem.

18. The method of claim 14, further comprising:
storing, by the storage operation subsystem in second superblock table for the second superblock and in response to performing the second storage operations for the second superblock using the second die in the storage subsystem, an identifier for the second die in the storage subsystem in association with a storage operation performance window.

19. The method of claim 18, further comprising:
storing, by the storage operation subsystem in the second superblock table for the second superblock in association with the storage operation performance window and in response to performing the second storage operations for the second superblock using the second die in the storage subsystem, an identifier for a wordline in the second die in the storage subsystem that was used to perform the second storage operations.

20. The method of claim 14, wherein each of the first storage operations and the second operations include at least one of program operations or erase operations.
